(19) United States
(12) Patent Application Publication
(10) Pub. No.: US 2004/0039847 A1
(43) Pub. Date: Feb. 26, 2004

(54) Computer system, method and network

(75) Inventors: Lars Persson, Harlosa (SE); Mikael Lofstrand, Farnham (GB)

Correspondence Address: MEYERTONS, HOOD, KIVLIN, KOWERT & GOETZEL, P.C., P.O. BOX 398, AUSTIN, TX, 78767-0398, US

(73) Assignee: Sun Microsystems, Inc.

(21) Appl. No.: 10/441,930

(22) Filed: May 20, 2003

Related U.S. Application Data
(60) Provisional application No. 60/381,874, filed on May 20, 2002.

(51) Int. Cl. G06F 15/16

(52) U.S. Cl. 709/250

(57) ABSTRACT

A server for a thin client network comprises a thin client network management and control module. The server also comprises a network interface mechanism which includes a broadband interface module and a narrowband emulation module inter-operable to provide a communications link to one or more thin client terminals on the thin client network. The management and control module is inter-operable with the network interface mechanism for providing a thin client network over a broadband network. Broadly speaking, the narrowband emulation module is superimposed on the broadband interface module to provide a network interface mechanism operable as an emulated narrowband interface. A thin client network implemented over a broadband network is also disclosed, together with a method for setting up and operating the same.

### BACKGROUND OF THE INVENTION

1. Field of the Invention

The present invention relates to computer networks. In particular, but not exclusively, to thin client networks, servers and client terminals for thin client networks, and methods for operating thin client networks, over metropolitan area networks

2. Description of the Related Art

Currently, conventional computer system networks for most businesses and organisations are based around a network connecting desk top computer system workstations to shared resources such as printers, scanners, e-mail servers and Internet servers, for example. The desk top workstations themselves have sufficient processing resources and local memory to provide a significant level of computational ability and are able to run software applications such as word processing applications, spread sheets, graphics packages and other business, scientific or technical application programs. The application programs may be installed on each workstation or downloaded over the network from the application server as and when required, for example. Such conventional networks are typically distributed over an office, or within a building or small campus environment, and cover a geographically small area. Such networks are generally known as Local Area Networks (LANs).

LAN protocols are widely known, and include Ethernet, Token Ring and Fibre Distributed Data Interface (FDDI) for example, and of which Ethernet is probably the most common LAN implementation technology.

In an Ethernet LAN implementation, client workstations can be located typically up to about 85 metres cable length away from the LAN server for twisted pair (10/100 BaseT) cable media, and up to two kilometres for optical fibre media (10/100 BaseFX-MM.

An undesirable aspect of conventional LAN networks having a number of processing or computational workstations distributed over the network is the cost of maintaining them. Information Technology (IT) specialists have to be deployed at the workstation user level in order to resolve problems with workstations, install application software and other necessary software, or point to programs stored on an application server. Typically further maintenance of the workstations is necessary. This is expensive. Additionally, computational workstations are expensive purchases and represent a significant capital investment and asset for many organisations.

Thin client networks are now being implemented in which relatively low processing power client terminals are coupled over a LAN network to one or more high power servers which run application software for users of the workstations. At the simplest level a thin client terminal comprises little more than a user interface device. The only processing power required is that sufficient for managing a display, keyboard and mouse for example. In this regard, the thin client terminal could be regarded by the server as a video card coupled to the LAN.

In a thin client network such as described above, data transfer across the network must be very reliable and effectively error-free (less than 0.1% packet loss). Furthermore, for the network not to be overloaded there must be sufficiently low latency and sufficient bandwidth in order to provide reliable data transfer. Such a high quality network is a necessary feature of a thin client system in order that a user of a thin client terminal does not experience delays or downtime due to poor data transfer and network quality. This is necessary since the performance of a thin client terminal is dependent upon the network performance.

LANs are not only restricted to a relatively small geographic area, but also to the number of thin client terminals they can support. A particular problem with large numbers of thin client terminals, typically greater than 200, is that there is over-utilisation of the LAN which causes any affected network segment to become congested. Collision detection and management functions generally halt traffic flow on the network whilst the collision is resolved. Another source of errors if the number of clients is too large is Address Resolution Protocol (ARP) or Reverse Address Resolution Protocol (RARP) request storms as various network attached devices, e.g. client terminals, simultaneously seek to initiate communications over the network.

Occasionally, with large numbers of clients, or in very large networks, duplicate IP addresses are issued which causes further errors.

Errors due to physical defects such as faulty connectors or cabling are more likely the more client terminals that are connected to the network.

LANs may be regarded as “narrowband” technology in that they can only be used for one type of traffic characteristic compared to “broadband” technology networks which can support different traffic characteristics. The terms “broadband” and “narrowband” are used in the foregoing sense in this description and do not relate to the data handling capacity of a network or network device.

### SUMMARY OF THE INVENTION

Particular aspects of the invention are set out in the accompanying independent claims. Combinations of features from the dependent and/or independent claims may be combined as appropriate and not merely as set out in the claims.

The present teaching relates to thin clients in Metropolitan Area Networks (MAN), and discloses a methodology and architecture for enabling thin client terminals to be used over long distances and scaling for a large number of users whilst retaining meaningful management of the MAN, and avoiding the problems typically associated with large numbers of client terminals operating over a narowwband network such as an Ethernet network.

One aspect of the present invention provides a server mechanism for a thin client network, comprising a thin client network management and/or control module. The server mechanism also comprises a network interface mechanism which includes a broadband technology network interface module (broadband interface module) and a narrowband technology emulation module (narrowband emulation module) inter-operable to provide a communications link to one or more thin client terminals on the thin client network. The management and/or control module is inter-operable with the network interface mechanism for providing a thin client network over a broadband communications technology network (broadband network). Broadly speaking, the narrowband emulation module is superimposed on the broadband interface module to provide a network interface mechanism operable as an emulated narrowband network technology interface (emulated narrowband interface).

Viewed from another aspect, the present invention provides a computer network, comprising data processing apparatus, in particular a computer system, incorporating a server mechanism as described above, and connectable to a broadband network. The computer network also comprises a thin client terminal which is configured to operate in accordance with a narrowband communications technology protocol (narrowband protocol). The thin client terminal is connectable to the broadband network via a broadband technology switch module (broadband switch module), the switch configured to provide an interface between a thin client network environment and said broadband network for communication between the thin client terminal and the data processing apparatus.

The foregoing aspects provide a server mechanism and network environment to support a thin client network architecture over a wide geographic area, such as a Metropolitan Area Network (MAN) for example. Client terminals configured to operate and communicate via narrowband protocols may be dispersed over a wide geographic area, yet still be coupled to communicate within a thin client narrowband technology network type environment. A business or organisation may have thin client terminals deployed in various numbers at different and widely dispersed geographic locations, yet still connect them to a centralised data centre using narrowband protocols, in a robust and reliable manner. Thus, centralised management and maintenance of the computer network and application programs, for example, is possible thereby avoiding a need for IT specialists to travel to or be stationed at geographically separate locations in order to support computational computer system workstations.

In one embodiment of a network a centralised data centre provides users with centralised data backup thereby offering data protection even to an individual user. Furthermore, the server mechanism and network may be configured to provide a thin client narrowband technology network type environment for non-associated users not being part of the same business or organisation, yet who require the benefit of a centralised maintenance and management network system for example, use of business application software as and when required on a per-unit time basis, the downloading or access to other software assets such as music or video, or even controlled access to e-mail and the Internet, for example. A particular example might be the use of such a centralised management system to provide virus protection software for the network, thereby protecting network users from contamination with viruses originating outside the network. In accordance with an embodiment of the present invention, it is possible for businesses, organisations and even individuals to outsource many of their computer environment needs such as e-mail, web access, office and business applications, and portal bound applications such as HTML and/or Java applications, by having these applications or services run or managed at a centralised location.

In one embodiment, a data processing apparatus is disposed in a Service Delivery Network server architecture and is configured to implement an access service to said Service Delivery Network for the thin client terminal. Such an embodiment may comprise a computer network such as described above, wherein the data processing apparatus is disposed in a Service Delivery Network server architecture and is configured to implement an access service to said Service Delivery Network for one or more thin client terminals in the network.

Suitable broadband technology switch modules may be located in residential areas by utilising one or more optical fibre connections and common narrowband techniques after the broadband network side to provide access to residential users. Thus, users could have access to 10 Mbps or 100 Mbps connections even when at home. Terminals connected to such switches may function as Internet “surfboards”, office carriers and mail tools. Net-bound applications on Internet portals can be substantially and instantly accessible by the terminals. An example of a service that may be provided in such an environment is a maintenance free “surfboard”, which may be an option for an Internet service provider's subscription. Such a maintenance free “surfboard” may be included as part of a cable or digital television service, and accessible via the set top box or, digital or web TV, for example. Such terminal devices do not run applications locally and therefore do not need to have software installed, upgraded or maintained to function. They only need to connect to the network. Thus, such terminals are protected from viruses.

Another example of an application of an embodiment in accordance with the present invention is the provision of educational services over computer networks. Educational services, along with other publicly provided services such as healthcare and local and national government services, generally operate under strict financial constraints. Instead of maintaining many tens or indeed hundreds of computer system workstations, plug-and-play thin client terminals may be set up and connected to a server providing the necessary applications via a thin client emulated narrowband technology protocol network (emulated narowband network) in accordance with an embodiment of the present invention. If a client terminal malfunctions, all that needs to be done is to replace it with another unit. Since the thin client terminals are not computational devices they are relatively inexpensive. Furthermore, replacing a thin client terminal of a type in accordance with an embodiment of the present invention does not require any reinstallation of application software. Furthermore, there is no need to maintain individual terminals with application upgrades since the applications are provided and running on a centralised server or servers. Additionally, any licensing costs associated with applications may be incorporated as a fee for access to the relevant application over the thin client emulated narrowband network, possibly on a data rate or per unit time basis. Servers for such a network could either be sourced outside or inside an educational services premises. This provides the option for the educational service to manage and maintain the networking applications themselves, or to outsource that aspect as well. In this way, not only schools but also hospitals, government bodies and other users of a network in accordance with the present embodiment are not required to upgrade their computer system workstations from time to time, nor do they have to maintain expensive IT departments.

A particular embodiment of a server mechanism includes a thin client network management and/or control module having a directory of file identifiers, of which one is modified to substitute an identifier of the network mechanism for an identifier of a narrowband communications technology network interface module (narrowband network interface nodule). Such an embodiment provides for the configuring of a server mechanism which would usually only initialise with a narrowband interface module to be configured with an emulated narrowband interface. This is a particularly convenient way of reconfiguring such a server mechanism.

The server mechanism may comprise a further network interface mechanism including a broadband interface mechanism and a narrowband interface module interoperable with the thin client network management and control module to provide a further thin client network environment over the broadband network, thereby providing multiple thin client network architectures controlled by a single server mechanism. Thus, there may be more than one broadband interface mechanism with a superimposed narrowband emulation interface thereby providing a plurality of emulated narrowband interfaces.

In a particular embodiment the narrowband emulation module comprises a Local Area Network Emulation (LANE) module. Such a LANE module may be operable for at least one of the following LAN protocolsEthernet and Token Ring.

In a particular embodiment the server mechanism further comprises a narrowband interface module, which may particularly comprise a LAN module. More particularly, the LAN module may be operable for at least one of the following LAN protocols, Ethernet, Token Ring and FDDI.

The server mechanism may be operable for more than one broadband protocols, in particular but not limited to Classical IP (CLIP), Permanent Virtual Circuits (PVC), Asynchronous Transfer Mode (ATM), Synchronous Optical Network (SONET) and Synchronous Digital Hierarchy (SDH). Typically, the server mechanism is implemented in a suitably configured data procesing apparatus, for example a computer system.

In one embodiment of a computer network according to the present invention, a client terminal is connectable to a broadband switch module via a narrowband switch with one or more broadband uplinks. A network of narrowband communications technology operable client terminals may be coupled by the narrowband switch through to the broadband switch module to form a part of the thin client network type environment. This provides for a plurality of thin client narrowband communications technology operable terminals to be coupled to a single port of the broadband switch. In a particular implementation, the narrowband network switch is a LAN switch thereby forming a virtual LAN. The LAN switch may be operable for at least one of the following protocols: Ethernet and Token Ring links.

Viewed from another aspect, the present invention provides a method of forming a thin client network over a broadband network, comprising configuring a server for a thin client network with a broadband network interface, and emulating a LAN controller on the server for the thin client network. The method further comprises configuring one or more broadband network switches to communicate with one or more thin client terminals in the thin client network to form a private emulated local area network with the server, and communicating LAN control signals to the one or more thin client terminals over the emulated private local area network.

Viewed from another aspect, the present invention provides a method of forming a thin client network over a broadband communications technology network comprising forming a virtual local area network over the broadband communications technology network, and configuring a server to emulate a LAN controller over a broadband network interface to control the virtual local area network, and coupling one or more thin client terminals to the virtual local area network for communicating with the server.

Viewed from another aspect, the present invention provides a method of configuring a server data processing apparatus for forming a thin client network over a broadband network, comprising initialising a server computer system with a LAN module, installing a LAN emulation (LANE) module interoperable with a broadband network interface, and modifying a pointer to the LAN module to point to the LANE module. By performing the foregoing method it is possible to force a server data processing apparatus inherently configured to operate with a LAN module, to use a LANE module. As far as the data processing server is concerned, it is still utilising a LAN module and therefore is capable of operating in accordance with its usual operating processing parameters, yet over the LANE module.

A particularly suitable embodiment of the data processing apparatus is a computer system. Suitably, the server mechanism may be implemented in software, firmware, hardware or any combination thereof, to provide an appropriate implementation in accordance with an embodiment of the present invention. In particular, a computer program product may be configured comprising machine or processor-readable program elements for configuring a processor to implement a server mechanism or method as described above. Typically the computer program is supported on a computer program carrier medium.

Therefore, a particular aspect of the present invention is a computer program product comprising a computer user or medium having a computer readable program code embodied in a computer usable medium and operable to effect the performance of a server mechanism for a thin client network, for forming a thin client network over a broadband network. In a particularly useful embodiment, a computer program product comprises a computer usable medium having a computer readable program code embodied therein operable to effect the configuration of a server mechanism for forming a thin client network over a broadband network, the computer readable program code comprising computer readable program code for causing at least one computer system to be initialised as a server computer system with a LAN module, install a LAN emulation module interoperable with a broadband network interface, and to modify a pointer to the LAN to point to the LAN emulation module.

The computer program carrier medium or computer program product may be a computer usable medium comprising one of the following set of media, including but not limited to: a signal including an optical, electronic or RF carrier signal, a magnetic disk or tape, solid-state memory, and optical readable and or writable disk, a compact disc and a digital versatile disk.

Particular embodiments of the present invention will be described hereinafter, by way of example only, with reference to the accompanying drawings in which like reference signs relate to like elements and in which:

### BRIEF DESCRIPTION OF THE DRAWINGS

FIG. 1 shows a schematic representation of a computer system;

FIG. 2 shows a schematic representation of a thin client terminal;

FIG. 3 shows a schematic representation of a thin client network domain in accordance with an embodiment of the present invention;

FIG. 4 shows a schematic illustration of a Sun Ray network using multiple switches for load sharing;

FIG. 5 is a schematic illustration of a Sun Ray network environment architecture in accordance with an aspect of the present invention;

FIG. 6 is a schematic illustration of a network architecture in accordance with an aspect of the present invention;

FIG. 7 is a schematic illustration of an implementation of the present invention over a metropolitan area network;

FIG. 8 schematically illustrates a embodiment of the present invention over a metropolitan area network such as a CITYnet;

FIG. 9 is a schematic illustration of an embodiment of the present invention viewed from a physical aspect;

FIG. 10 is a schematic illustration of an embodiment in accordance with the present invention viewed from a functional aspect;

FIG. 11 is a schematic illustration of an embodiment in accordance with the present invention viewed from a logical perspective;

FIG. 12 illustrates process flow for configuring a Sun Ray server to communicate over a broadband interface card in accordance with an embodiment of the present invention;

FIG. 13 illustrates a process flow for installing an upgrade to Sun Ray server software in a server configured to communicate over a broadband interface card;

FIG. 14 schematically illustrates the components of a Service Delivery Network (SDN);

FIG. 15 schematically illustrates the logical architecture of a SDN;

FIG. 16 schematicall illustrates network equipment components for a SDN service module;

FIG. 17 illustrates a graphical representation of host servers within a service domain;

FIG. 18 schematically illustrates the components of a service module;

FIG. 19 schematically illustrates two service modules linked via a distribution module; and

FIG. 20 schematically illustrates an SDN logical layer model.

FIG. 21 illustrates various components of a service delivery network (SDN).

FIGS. 22A and 22B contain a graphical overview of an SDN.

FIG. 23 shows a graphical representation of a service domain.

FIG. 24 graphically shows the components of a service module.

FIG. 25 graphically shows how distribution models can be used to integrate multiple service modules.

FIG. 26 graphically shows three layers of the service and distribution modules.

FIG. 27 graphically shows an integrated security module supported by the SDN.

FIG. 28 illustrates an example of an integration security module.

FIG. 29 illustrates an example of a service security module.

FIG. 30 illustrates load balancing switches and post connection switches.

FIG. 31 graphically shows the layout of corporate internet deployment.

FIG. 32 graphically shows the layout of the medium size ISP deployment.

FIG. 33 graphically shows the layout of the large size ISP deployment.

FIG. 34 graphically shows the layout of the multi-customer listing provider deployment.

FIG. 35 illustrates load sharing over multiple network trunks.

FIG. 36 shows two LANs using the same switch.

FIG. 37 illustrates a MAN that has a data center with four Sun Ray domains.

FIG. 38 illustrates an exemplary equipment setup.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

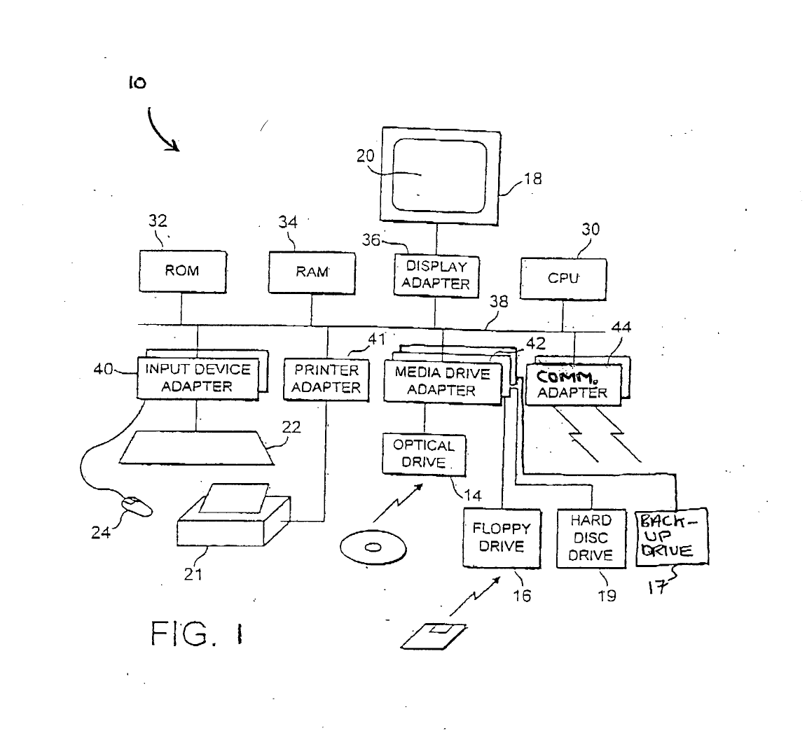

FIG. 1 shows a schematic and simplified representation of a data processing apparatus in the form of a computer system 10. The computer system 10 comprises various data processing resources such as a processor (CPU) 30 coupled to a bus structure 38. Also connected to the bus structure 38 are further data processing resources such as read only memory 32 and random access memory 34. A display adapter 36 connects a display device 18 having screen 20 to the bus structure 38. One or more user-input device adapters 40 connect the user-input devices, including the keyboard 22 and mouse 24 to the bus structure 38. An adapter 41 for the connection of the printer 21 may also be provided. One or more media drive adapters 42 can be provided for connecting the media drives, for example the optical disk drive 14, the floppy disk drive 16, hard disk drive 19, and high volume storage backup drive 17, to the bus structure 38. One or more telecommunications adapters 44 can be provided thereby providing processing resource interface means for connecting the computer system to one or more networks or to other computer systems or devices. The communications adapters 44 could include a local area network adapter, typically configured as a network interface card, a modem or ISDN terminal adapter and/or broadband communications technology interface, or serial or parallel port adapter etc, as required.

In operation the processor 30 will execute computer program instructions that may be stored in one or more of the read only memory 32, random access memory 34 the hard disk drive 19, a floppy disk in the floppy disk drive 16 and an optical disc, for example a compact disc (CD) or digital versatile disc (DVD), in the optical disc drive or dynamically loaded via adapter 44. The results of the processing performed may be displayed to a user via the display adapter 36 and display device 18. User inputs for controlling the operation of the computer system 10 may be received via the user-input device adapters 40 from the user-input devices.

A computer program for implementing various functions or conveying various information can be written in a variety of different computer languages and can be supplied on carrier media. A program or program element may be supplied on one or more CDs, DVDs and/or floppy disks and then stored on a hard disk, for example. A program may also be embodied as an electronic signal supplied on a telecommunications medium, for example over a telecommunications network. Examples of suitable carrier media include, but are not limited to, one or more selected from: a radio frequency signal, an optical signal, an electronic signal, a magnetic disk or tape, solid state memory, an optical disk, a magneto-optical disk, a compact disk and a digital versatile disk.

Computer system 10 may be configured as a server computer system for a computer network, in particular for a thin client network. In such a configuration, not all the input or output devices would be necessary, for example the display, keyboard, mouse and printer may be unnecessary.

It will be appreciated that the architecture of a computer system could vary considerably and FIG. 1 is only one example.

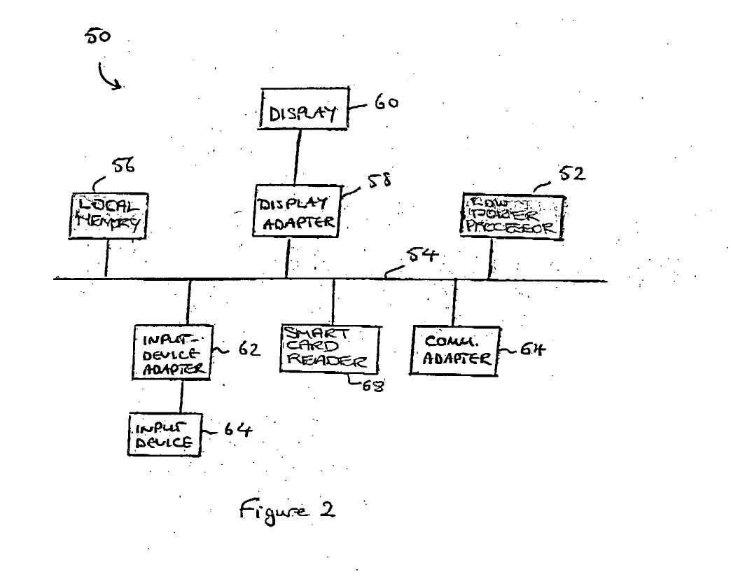

FIG. 2 shows a schematic and simplified representation of a thin client terminal. The thin client terminal 50 comprises various data processing resources such as a processor 52 coupled to a bus structure 54. Also connected to the bus structure 54 are further data processing resources such as local memory 56. A display adapter 58 connects a display 60 to the bus structure 38. A user-input device adapter 62 connects a user-input device 64 to the bus structure 54. A communications adapter 64 is provided thereby providing an interface means for the user device to communicate across one or more networks to a server computer system, such as an appropriately configured computer system 10 for example. A thin client terminal may be configured with only user-input or user-output device adapters 58, 62 and 64, a display, keyboard and mouse being supplied and connected separately, for example. A smart card reader 68 is also coupled to bus structure 38.

In operation the low power processor 52 will execute instructions that may be stored in memory 56, and which are substantially limited to controlling the thin client terminal. In its most simple form, the client terminal is little more than a video card, with user input devices, for displaying information from, and communicating information to, a server computer system.

It will be appreciated that the architecture of a thin client terminal could vary and FIG. 2 is only one example.

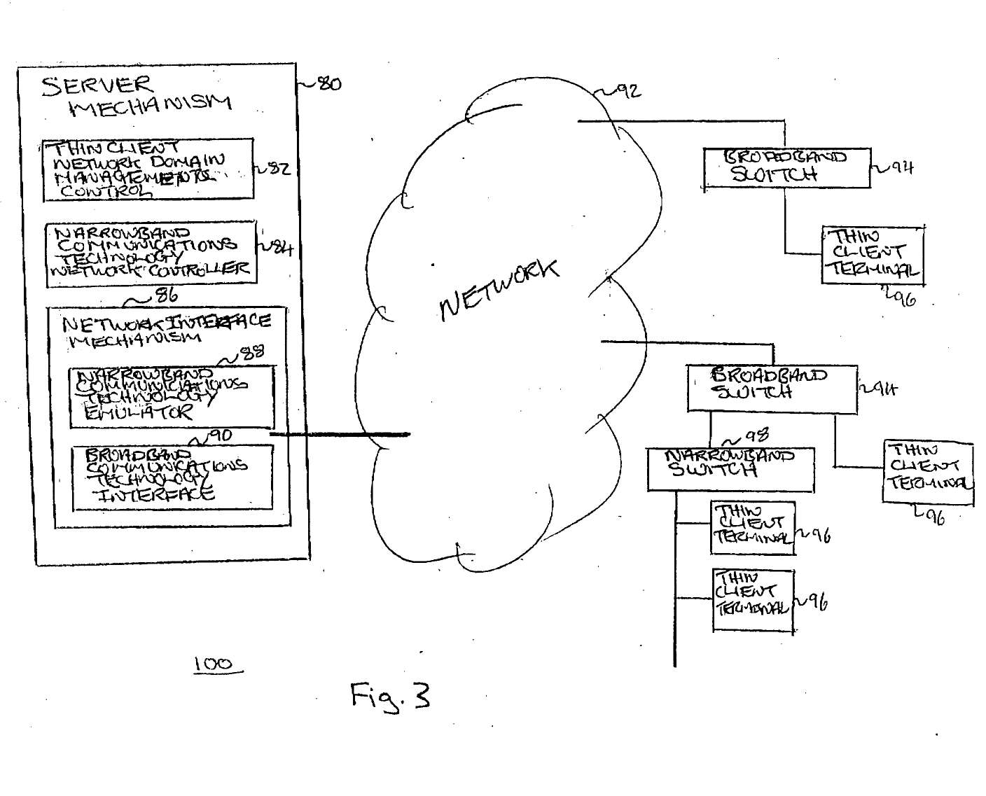

FIG. 3 illustrates the functional architecture of an embodiment of the invention forming a thin client network domain 100 over a broadband communications technology network (broadband network) 92.

A server mechanism 80 provides a network server function to support the thin client network domain 100. The server mechanism 80 may be implemented by any one or combination of software, firmware or hardware. Implementation of the server mechanism 80 may be by way of a computer system 10, appropriately configured with a server program, network interface card and hardware components such as cable connectors for example.

Server mechanism 80 includes a thin client network domain management and/or control module 82, hereinafter referred to as a thin client domain control module, for controlling security and access to the thin client domain amongst other things.

The illustrated server mechanism 80 also includes a narrowband communications technology network controller 84. The term narrowband communications technology is used herein to refer to a communications technology which can support only one sort of communications traffic. Examples of narrowband communications technologies are Ethernet, Token Ring, and FDDI.

Taking Ethernet as an example, communications traffic is encapsulated as frames containing a header having source and destination station addresses and a trailer container error correction data. Only traffic in the Ethernet frame format can be communicated over the Ethernet network. A higher level communications protocol such as the Internet Protocol (IP) fragments long messages into the frame size required by the Ethernet protocol.

On the other hand, the term broadband communications technology is used herein to refer to a communications technology which can be used to communicate many different types of communications traffic, with different traffic characteristics. That is to say, broadband communications technologies are not limited to a single link protocol (e.g. Ethernet protocol) or computer related data communications only. For example, voice over IP is not broadband since the audio is digitised and sent as IP packets, whereas on broadband communications technologies voice can be sent as a separate channel without encapsulating it into a computer communications protocol.

There are three main types of broadband communications technology, namely:

constant bit rate (time critical) communications such as for video streams;

available bit rate (in order packet delivery) such as for telephone systems; and

unspecified bit rate (error free communications such as typically used for data communications)

Three examples of broadband communications technologies are Synchronous Optical Network (SONET) typically used in North America; Synchronous Digital Hierarchy (SDH) typically used in Europe; and broadband Integrated Services Digital Network (ISDN) operating in an Asynchronous Transfer Mode architecture. ATM can be implemented by itself or over a SONET or SDH system. These communications technologies may be adapted to form a physical layer, communications media layer, for narrowband technologies such as a LAN technology.

Although broadband technologies (such as SONET, SDH and/or ATM) can be utilized to transport data, they are mostly used for other purposes (such as telephony, raw video streams, for example). When broadband is used for data communications it is mostly as a transport media for WAN (Wide Area Network) communications. Broadband technologies are mostly used by telecommunications companies and similar operations to handle large quantities of various communication needs through as few physical connections as possible. As a rule, very few computer networks have this need. In order to emulate some of the trunking abilities of broadband, it is often possible to transport several narrowband networks over one broadband connection. This is done by introducing an identification tag in the actual data packet that binds it to a certain LAN. The switching hardware can then sort out the different packets based on their tags and route them to their correct destination. This does not change the narrowband characteristics since only data communications are transported over the broadband connection.

Narrowband trunking as described above considerably increases general network latency compared to broadband trunking, and generally it is advisable to avoid narrowband trunking for latency prone equipment.

When using alternative paths in a load sharing set, narrowband technology can cause packets to be delivered to the destination out of order. This is not the case with correctly used and configured broadband technologies.

Referring back to FIG. 3, server mechanism 80 also includes a network interface mechanism 86 for providing communications between server mechanism 80 and network 92. Network interface mechanism 86 includes a narrowband communications technology emulation module (narrowband emulation module) 88 and a broadband communications technology network interface (broadband network interface) 90. Each of the narrowband emulation module 88 and broadband network interface 90 may be implemented in software, firmware, hardware or any combination thereof. The narrowband emulation module 88 may form a part of or be integrated with the broadband network interface 90, or be a separate module therefrom.

The narrowband emulation module 88 provides network management and control information through the broadband network interface 90 over network 92 to narrowband communications technology terminals, such as thin client terminals 96. The narrowband emulation module 88 operates a narrowband network domain 100 over the broadband network 92.

A number of thin client terminals 96 are coupled to network 92 via broadband communications technology switches 94. The broadband switches 94, generally known as edge devices or proxy switches, convert the broadband communications technology signals received from network 92 to narrowband communications technology signals for thin client terminals 96. Switches 94 are configured to set up separate virtual narrowband communications technology networks on a per port basis.

In one implementation a narrowband switch 98 may be coupled to a port of a broadband switch 94 to provide a narrowband network for a plurality of thin client terminals 96.

A particular example of a thin client terminal operating over a narrowband network is a Sun Ray terminal, generally referred to as a Sun Ray Appliance and available from Sun Microsystems Inc, Palo Alto, Calif., USA. One example of a Sun Ray Appliance includes a smart card reader, such as shown schematically as reference 68 in FIG. 2. A particular embodiment in accordance with an aspect of the present invention will now be described with reference to Sun Ray Appliances (terminals), servers and networks. However, the skilled person will appreciate that embodiments of the invention are not limited to Sun Ray systems, but may employ other types of data processing apparatus, computer systems, terminals and networks.

The Sun Ray thin client system requires very little administration, management or support of the Sun Ray Appliance at the user level. The Sun Ray Appliance does not need to be pre-configured to function, and may be installed by merely connecting the Sun Ray Appliance to its keyboard, mouse, screen and network. Sun Ray Appliances have a very small physical footprint and are extremely rugged and dependable. They are not high power processing or computational devices and once powered up are substantially instantly accessible to the user. Since there is very little processing carried out in the Sun Ray Appliance there is very little heat generation and they do not need forced cooling, and therefore do not have fans, making them very quiet.

Sun Ray Appliances are centrally administered by very powerful Sun Ray control software making them suitable as a highly cost efficient alternative to a traditional high power processing, computational workstation.

A particularly useful feature of a Sun Ray Appliance is its smart card function. When using smart cards, the session displayed on the Appliance is tied to the identification number of the smart card and not to the Appliance itself. Thus, it is possible to move a current session to another Sun Ray unit simply by removing the card and inserting it into another Sun Ray Appliance. A smart card is not necessary for use of a Sun Ray Appliance, but if not used the session will be tied to the physical Sun Ray unit on which the session is being run. An advantage of the smart card function is that it makes the Sun Ray Appliance both session persistent and session dependent at the same time. Optionally, there has become available Sun Ray server software (SRSS) in which there is non-smart-card mobility enabling user sessions to be hot-desked without a smart card.

Referring now to FIG. 4, there is illustrated a conventional Sun Ray network, which for the purposes of simplicity shows a single Sun Ray Appliance 120 coupled via an Ethernet network 122 to a Sun Ray server 124. Sun Ray Appliance 120 may be described as a terminal device with no local computing environment, and requires a connection to Sun Ray server 124 in order to operate. Sun Ray Appliances 120 connect to their servers 124 via a dedicated Sun Ray network, in the illustrated embodiment an Ethernet network 122, using standard TCP/IP protocols. The dedicated Sun Ray network is often referred to as a backnet. Sun Ray Appliances 120 communicate over the back net using User Data Protocol (UDP) which is a protocol in the TCP/IP protocol suite which may be used in place of TCP. However, UDP does not include any control data in the data packets such as order information or information to identify any missing packets. Consequently, UDP can only be used in environments in which lost packets or packet collision does not matter, or does not or is extremely unlikely to occur.

Within the Sun Ray system, the Sun Ray server 124 may be the application program carrier. A Sun Ray Appliance user logs in to the Sun Ray server via the Sun Ray Appliance in order to run their programs, which are displayed to them on their local screen. The only program code running on a Sun Ray Appliance is micro code to control and operate the communication between the Sun Ray Appliance and the Sun Ray server. Thus, the processes being used by Sun Ray Appliance user are not dependent on the state of the Sun Ray Appliance itself, but on the quality of the network connection to the Sun Ray server. Thus, there needs to be a high quality network over which the Sun Ray Appliances communicate to the Sun Ray server 124. Therefore, the Sun Ray backnet, in the illustrated embodiment an Ethernet, must be substantially error free. That is to say, there should be less than 0.5% packet loss, in particular less than 0.2% packet loss and more particularly less than 0.1% packet loss in the backnet. Furthermore, the backnet must not be overloaded, must have low latency and sufficient bandwidth to manage the Sun Ray data traffic in order for the Sun Ray Appliances not to lose their connection to the server, or provide an unacceptable level of service to the Sun Ray Appliance user.

The Sun Ray server can in principle be any reasonably modern computer system, such as a Sun Microsystems computer system, configured to implement Sun Ray server processes and methods and that has sufficient capacity to manage the processes which Sun Ray Appliances wish to use, at an appropriate data bandwidth. The Sun Ray server may provide the application carrier for the Sun Ray network. Optionally, the Sun Ray server may be a separate data processing apparatus to the servers acting as application carriers.

Sun Ray Appliances operate in accordance with the Dynamic Host Configuration Protocol (DHCP). The Sun Ray Appliance 120 boots up as a dataless terminal which configures itself by downloading the software it needs to function from the Sun Ray server over the backnet. When booted up the Sun Ray Appliance sends out its Ethernet address on to the backnet, and it is received by the Sun Ray server which responds by sending back appropriate micro code to the relevant IP address contained in the Ethernet packet. Thus, there is minimal support required for initialising a Sun Ray Appliance. The Sun Ray Appliance when initialised is perceived by the Sun Ray server as substantially another video card with additional hardware such as a mouse, keyboard and smart card reader for example.

In some configurations, the Sun Ray server 124 is coupled to a public network often known as a frontnet such as a corporate LAN. Sun Ray users can have their application servers other than with the Sun Ray server itself, for example as servers on the front net. When calling an application, the appropriate application is loaded and processed on the application server but displayed on the Sun Ray Appliance through the Sun Ray server.

External to the backnet, i.e. from the frontnet, a Sun Ray appliance is seen as originating from the IP address of the Sun Ray server frontnet interface, and not from the real IP address of the Sun Ray Appliance on the backnet. This means that there is no routing between a Sun Ray Appliance on the backnet and the frontnet. A Sun Ray Appliance is identified within the backnet via the display number issued by the Sun Ray server to it on initialisation. This is the means by which appropriate display data can be sent from the Sun Ray server to the correct Sun Ray Appliance.

A limitation of the Sun Ray system technology has been its modest ability to function effectively over long distances whilst retaining a high degree of redundancy. The particular requirements of the Sun Ray backnet environment preclude increasing the size of a Sun Ray backnet, establishing such backnet over a wide area and using applications requiring high data bandwidth transmission over the backnet. This is due to the very high demands and the quality of the backnet that the Sun Ray system requires. In summary, the demands of the Sun Ray backnet environment are as follows:

sufficient bandwidth (which is application dependent);

low latency (less than 100 mill seconds, particularly 50 mill seconds round-trip between Sun Ray server and Sun Ray Appliance);

ensured in-order packet delivery; and

near error free networks (less than 0.5%, in particular less than 0.2% and more particular less than 0.1% packet drop)

Although errors can occur within the Sun Ray backnet environment they must be insignificant.

In an Ethernet environment such as Ethernet network 122, the errors are usually caused by over-utilisation, mis-configuration of the network or physical defects on a disc segment of the Sun Ray server causing packets to be dropped.

Over-utilisation causes collisions. The collision detect (CD) function of Ethernet networks causes communication to cease for a certain time frame if collisions are detected. Consequently, collisions can destroy, fragment or mis-align packets sent over the network at the moment of collision. Therefore, the CD function causes latency. That is to say, there is a delay in the transmission of packet data due to collision detection. Collisions may be so bad that communication can effectively become impossible (collision storms) in a particular segment of a network. However, the use of duplex mode Ethernet switches can reduce the likelihood of collisions.

Mis-configurations of the network can also cause errors and result in Address Resolution Protocol (ARP) or Reverse Address Resolution Protocol (RARP) storms.

Physical defects causing lost or corrupted data packets may be introduced by terminating equipment such as the Sun Ray Appliance or Sun Ray server themselves, or any other Ethernet-connected device such as a network printer. Additionally, network transfer equipment such as switches, hubs or concentrators also introduce physical defects. However, the most common source of physical defects is from faulty cabling or connectors.

Collision detection management is closely associated with there being sufficient bandwidth on the network for handling the likely volume of traffic that will be placed on the network. Techniques for evaluating the likely capacity of a network and calculating peak lows, average lows and minimum lows in order to deduce the capacity needed for the various networks components are well understood, and will not be described further here.

Within a network environment, for example the Ethernet supporting the Sun Ray system backnet, the network components each introduce a delay into the transmission of data packets between Sun Ray Appliance and Sun Ray server. In this regard, latency can be thought of as equipment handling time. Within Sun Ray environments, low latency is extremely important since the performance of the Sun Ray Appliance is almost totally dependent upon network performance. Latency is not only caused by collisions as referred to above, but also due to inter-LAN links.

VLAN technologies can also introduce latency. Two implementations of VLANs are per port VLANs and tagged VLANs. Per port VLANs are formed by re-wiring the actual ports of a network switch into groups which mutually exclude each other. On the otherhand, tagged VLANs have to open each data packet, insert a piece of information identifying the VLAN to which that data packet belongs, re-package the data and then send it out onto the network. Thus, several LANs can exist on the same media, typically between two switches, implemented by way of VLANs. For tagged VLANs when data arrives at the next switch each packet has to be checked in order to determine which VLAN it relates to, and a decision has to be made and the packet has to be sent to the correct destination or VLAN. If the network switch is unable to cope with the volume of data then it will go into “hub mode” and send copies of every packet to every VLAN segment regardless of whether the packet belongs there or not in an attempt to ensure that some packets at least reach their proper destination. Such behaviour is unacceptable in a Sun Ray network, and therefore those skilled in the art of designing and implementing Sun Ray networks have hitherto not contemplated utilising tagged VLANs.

Per port VLANs may also switch over into “hub mode” if the data flow is overwhelming, but since network switches implementing per port VLANs do not have to open up data packets to identify the appropriate VLAN then they can cope with a higher volume of data so it is less likely they will become flooded. Nevertheless should they become flooded with data and overloaded then they will switch into “hub mode”. For this reason persons skilled in the art of designing and implementing Sun Ray systems have not contemplated implementing them using per port VLANs where very large volumes of data traffic are expected.

This technical prejudice against implementing Sun Ray systems over anything other than LANs, and the prejudice that dedicated Ethernet interconnects should be utilised, are disclosed in a white paper published by Sun Microsystems. Inc. dated 1999 and available at URL “http://[World Wide Web].sun.com./products/sunray/whitepapers/sunray1.scaleability.wp.pdf”, and entitled “Assessing Scaleability of the Sun Ray (TM) 1 Enterprise Appliance”; and Sun Microsystems, Inc. white paper entitled “Sun Ray Appliance Overview and Technical Brief” dated 1999 and available from URL “http://[World Wide Web].sun.com./products/sunray/whitepapers/sunray1.overviwe.wp.pdf”, both downloadable at least as of May 16, 2002.

In light of the foregoing, persons skilled in setting up and configuring Sun Ray networks seek to make the architecture as uncomplicated as possible. Furthermore, they do not connect Sun Ray appliances over large distances or WAN networks, or in large numbers, but restrict Sun Ray networks to LANs with relatively low numbers (about less than 200) of Appliances connected to them.

As already mentioned above, Sun Ray appliances use UDP as the information carrier packet format. However, using UDP means that there is no way for the network to determine if the packets arrived in the correct order since no order information is contained within the UDP packets. Control and management of the order of the information has to be handled at the application layer. It cannot be handled at the network layer. In the Sun Ray network environment, out of order packets are considered lost packets. This is a desired restriction of the Sun Ray environment. However, considering out of order packets as lost packets causes a problem in a backnet which utilises multiple network trunks, such as is shown for example in FIG. 4. Ethernet network 122 forms the backnet for an illustrative Sun Ray network environment which a single Sun Ray appliance 120 is illustrated coupled via a combination of Ethernet switches 126 to Sun Ray server 124. Although the Sun Ray appliance 120 can tolerate occasional out of order packets in its communication with the Sun Ray server 124, as mentioned before any errors caused by such out of order packets must be insignificant. Consequently, if out of order packets occur too frequently those Sun Ray appliances are unlikely to work within the backnet environment. An example of how out of order packets may occur will now be described with reference to FIG. 4.

In the illustrated network of FIG. 4, Ethernet switches 126 are set up as a load-sharing set. A packet from Sun Ray appliance 120 can travel over a first inter-switch trunk leg 128(a) from Ethernet switch 126(a), to Ethernet switch 126(b) and then over inter-switch trunk 128(b) to Sun Ray server 124. The next packet sent from Sun Ray appliance 120 may be forwarded from Ethernet switch 126(a) over inter-switch trunk leg 128(c) to Ethernet switch 126(c), depending upon the loading for the Ethernet switches 126 at the time that data packet is transmitted. Ethernet switch 126(c) then forwards the packet over inter-switch trunk leg 128(d) to Ethernet switch 126(d) and then to Sun Ray server 124. The latency incurred at each section of the backnet 122, i.e. at the Ethernet switches 126 or over the inter-switch trunks 128, depends on a fixed constant for the hardware plus a variable based on the load of the particular device in question. Furthermore, due to inconsistencies in manufacturing, and physical defects in connecting and cabling such as discussed above, individual components may have different latency to each other. Thus, a packet leading Sun Ray Appliance routed over inter-switch trunk 128(a) may arrive later than a packet routed over inter-switch trunk 128(c). The Sun Ray server has limited means to determine whether or not this has happened. Evidently, the same problem occurs for packets which are transmitted from the Sun Ray server 124 to the Sun Ray Appliance 120. Indeed, for such a direction there is even less possibility for out of order packets being accounted for since the Sun Ray Appliance has no computing environment and therefore cannot compensate for out of order packets locally.

In summary therefore a Sun Ray backnet must be almost error free, have sufficient for capacity handling data transmitted over it, low latency and ensure that packets arrive in the same order as they were sent. This effectively rules out shared media such as co-axial cables, hubs and fan-outs even though the network protocol, such as Ethernet, may support such media. In order to support such requirements, Sun Microsystems, Inc have recommended the use of modem Ethernet switches with duplex capabilities, and connecting only one Sun Ray Appliance per switch port. Furthermore, it has been recommended that the sum of all traffic generated by Sun Ray Appliances should not exceed the capacity of the network interface of the Sun Ray server. These requirements and restrictions, amongst others, represent the established understanding of how a Sun Ray network environment should be configured within the limitations that are placed upon a narrowband network such as an Ethernet network. The foregoing described technical prejudice is well established within the Sun Ray network engineering community.

A further limitation of a LAN (Ethernet) implemented backnet for a Sun Ray network environment is that the distance between a Sun Ray Appliance and its server is limited by the physical media connecting them. Distances are generally measured in what are called “segment lengths”. A segment may be defined as a portion of a network having a network or apparatus at either end. For example, a network configuration in which a Sun Ray Appliance is connected to the Sun Ray server without any intermediate network devices will be described as a segment length of one. For twisted pair media, such a segment length can be approximately 100 metres long. If a greater separation is required then intermediate network devices must be utilised in order to provide a repeater function for the signals between the Sun Ray Appliance and Sun Ray server. Optionally, media other than twisted pair can be used such as optical fibre technologies. Optical fibre technologies are long distance media and will reduce the need for intermediate network devices such as inter-switch trunk segments that would increase latency such as described above. Typically two types of optical fibre are used for data communication. Multi-mode fibres are used for ranges up to two kilometres, and single mode fibres for ranges up to and in some cases exceeding, 60 kilometres. Optical fibre is not restricted to running TCP/IP or pure Ethernet protocol signals, but is a general communications media. Optical fibre segments do not add any significant latency to communications since even when run over large distances the speed of the light in glass is sufficiently fast that latency can be considered to be zero even for distances of 60 kilometres or more.

However, even if long distance communications media is available, such as optical fibre, it only provides connection between geographically disperate terminals. It does not provide for large scale Sun Ray networks, since the number of Sun Ray Appliances that can be accommodated on a single Ethernet is limited by the Ethernet control and management software. For example, if there are too many Sun Ray Appliances on the network, then there will be a significant number of collisions, and also address resolution protocol messages which will tend to use up the majority of the available data band width and clog the network with control management messages.

It has been recognised that it would be desirable to have a Sun Ray type network distributed over a large geographical area, with a large number of Sun Ray Appliances coupled to it in order to provide the benefits of a centralised data centre over a large geographical area. This may provide improved logistical and administrative management of computer networks from a centralised location, thereby providing cost and time savings for the organisation running such a network. The foregoing described drawbacks limitations of the Sun Ray system have precluded the implementation of such networks.

Long distance communications technologies such as those suitable for implementing a WAN are available, and are often operated by telecommunications companies using broadband communications technology networks. These technologies may be described as connection oriented, call oriented information transfers since they are primarily directed at establishing circuit-switched connections for telephone calls. Examples of such basic carrier technologies are SONET and SDH technologies. However, SONET/SDH type basic communications carriers are unsuitable for managing large scale computer data communications and/or a large numbers (about more than 200) of computers. The complexity of configuring the necessary switches to set up the direct connections between each computer is prohibitive. Furthermore, any changes such as connecting a new computer, or changing the location of an existing computer, are also prohibitively comlex and increase the complexity of the overall system yet further. Consequently, such communication carrier technologies are considered unsuitable for implementing large scale computer networks.

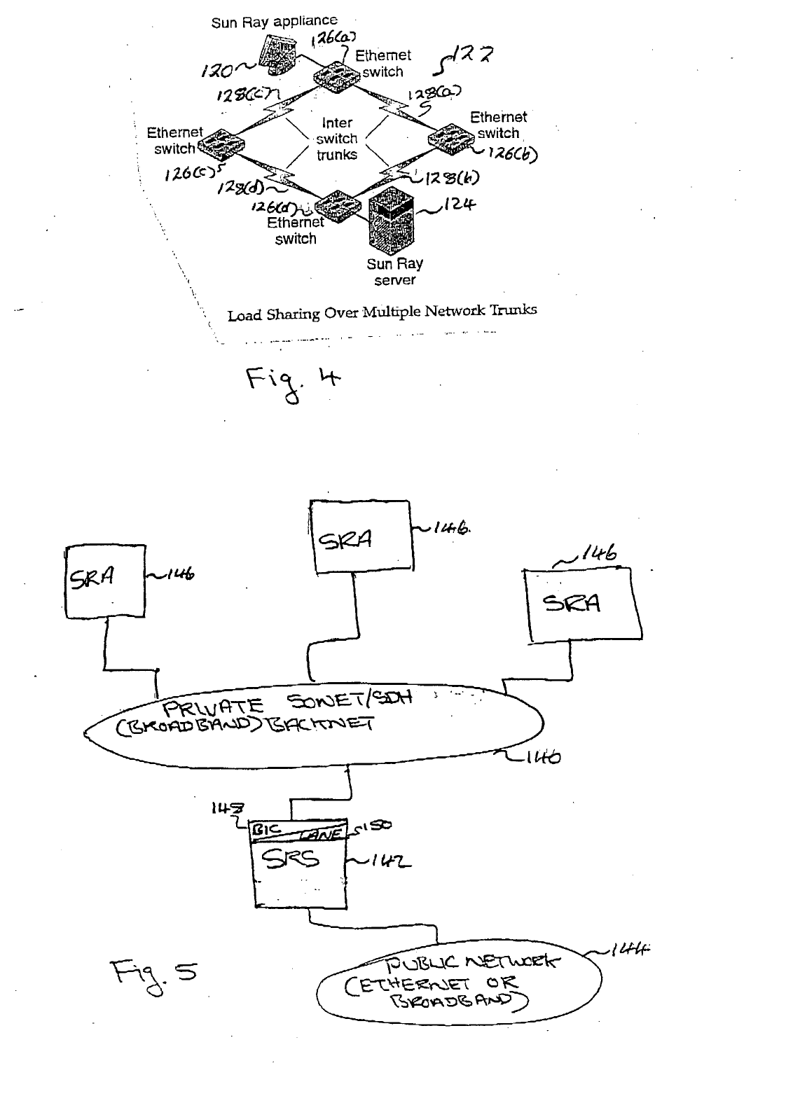

The applicant has recognised that the foregoing described drawbacks and limitations of Sun Ray network may be overcome by forming an appropriate Sun Ray network architecture and establishing a WAN by utilising a long distance communications technology such as SONET/SDH. In accordance with one aspect of the invention, a Sun Ray network environment is implemented over SONET/SDH—type communications network by providing an additional ATM (or broadband ISDN) control layer and utilising LANE V2.0 (LAN emulation software for network control). A schematic representation of an illustrative architecture for such a Sun Ray network environment is illustrated in FIG. 5.

In accordance with an aspect of the present invention as illustrated in FIG. 5, the Sun Ray network environment is implemented over a private SONET/SDH—communications carrier backnet 140. Sun Ray server 142 is coupled to the backnet 140 for controlling the Sun Ray backnet environment and, also to a public network frontnet 144 for providing communications outside of the Sun Ray backnet environment. Individual Sun Ray Appliances 146 communicate with the Sun Ray server 142 over the backnet 140. In a particular embodiment, Sun Ray server 142 may comprise a server mechanism 80 such as illustrated in FIG. 3. The network interface mechanism 86 comprises a broadband communications technology interface 90 operable to communicate over a SONET/SDH network. In this particular embodiment interface 90 is a SONET/SDH-capable broadband interface (BIC) card configured to utilise ATM and Ethernet emulation software LANE 2.0 for communication over the 140 to the Sun Ray appliances 146. A suitable BIC may be obtained from Marconi Networks. Marconi Networks BICs support UNI trunking which provides for several BICs being combined to form a single broadband interface conglomerate.

The LANE software may form a separate module such as is illustrated as narrowband communications technology emulator 88 in FIG. 3, or may be installed on the BIC Interface 90. The broadcast interface card BIC adapted for SONET/SDH (ATM) is labelled 148 in FIG. 5, and the local area network Ethernet information software LANE is labelled 150 in FIG. 5. Additionally, Sun Ray server 142 incorporates a suitable broadband network interface such as a SONET/SDH (ATM) broadband interface card for communicating over a public network 144 which forms the frontnet for the Sun Ray network environment illustrated in FIG. 5.

Optionally, the frontnet could be narrowband, and interfaced to Sun Ray server 142 using a standard narrowband LAN card (Ethernet, Token Ring or FDDI, for example). Thus, the Sun Ray architecture may be adapted to work with legacy core backbones.

BIC 148 can support several instances of local area networks, each one running LANE software. Furthermore, more than one BIC can be coupled together to form a trunked Interface. In the particular embodiment up to four BICs may be trunked together. Since the bandwidth for each BIC card is 155 megabytes per second or 622 megabytes per second the maximum bandwidth for Sun Ray server 142 can be up to 2.5 gigabytes per second, if a total of 4 BICs are used. The trunked interface for Sun Ray server 142 can be altered and may comprise two or three trunked BICs to form an interface for a particular instance of a LAN. The Sun Ray server 142 implements automatic load sharing between BICs forming a part of a trunked interface, and also in the event of a failure of any particular BIC. A typical maximum distance from the embodiment illustrated in FIG. 5 is 60 kilometres per segment. That is to say, 60 kilometres between network devices such as repeaters or switches for example.

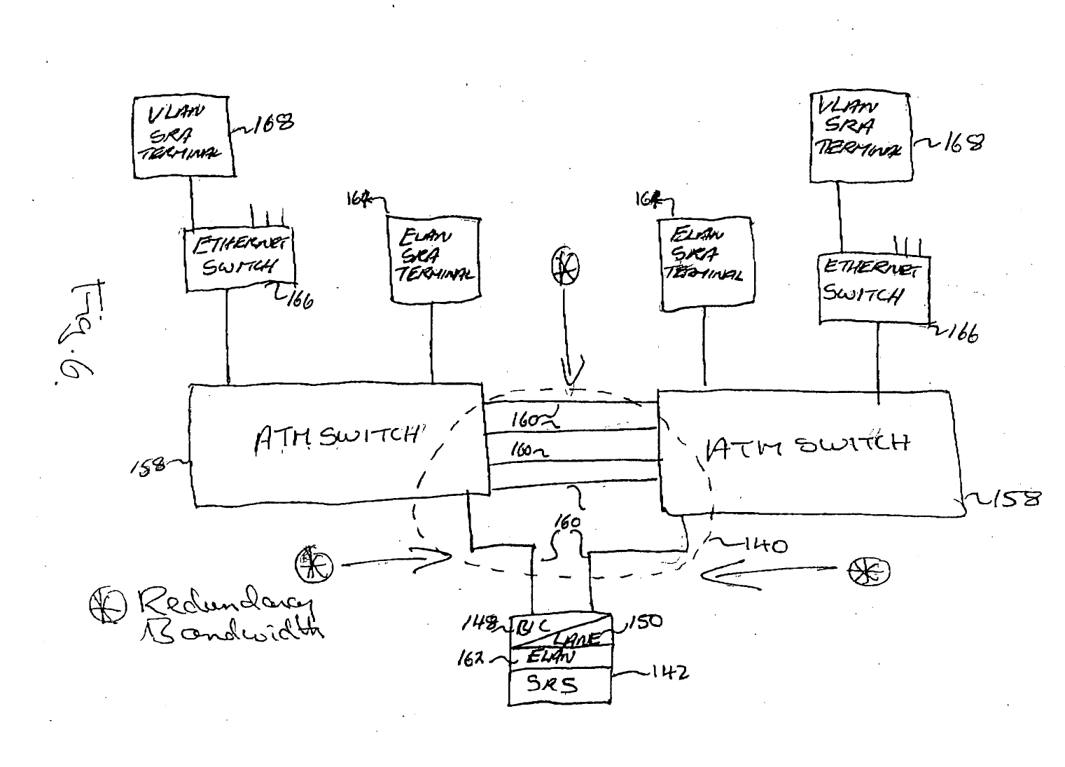

Referring now to FIG. 6, there is illustrated the functional architecture of a particular embodiment in accordance with the present invention utilising emulated LANs (ELAN) and virtual LANs (VLAN) configurations. Sun Ray server 142 comprises one or more BICs implementing a local area network emulator 150. Sun Ray server 142 effectively acts as an emulated LAN (ELAN) Ethernet controller 162 for controlling the Sun Ray Appliance terminals of the WAN 140. At the edges of WAN 140 are disposed ATM switches 158 often referred to as edge devices or proxy switches. Such switches 158 may be coupled to each other and to other network devices within WAN 140 by telecommunication lines 160. The telecommunication lines 160 have sufficient bandwidth and redundancy to provide reliable inter connection between the ATM switches 158 and Sun Ray server 142. The ATM switch edge devices may be coupled directly to a Sun Ray Appliance terminal 164, provided the port to which the Sun Ray Appliance terminal 164 is coupled supports Ethernet. The Sun Ray Appliance terminal 164 is part of the emulated LAN controlled by the ELAN controller 162. An Ethernet switch, 166, sometimes referred to as a proxy or edge device, with an ATM uplink may also be coupled to ATM switch 158. Ethernet switch 166 can form a virtual LAN network to which are coupled VLAN Sun Ray Appliance terminals 168. The Ethernet switch 166 may support more than one VLAN Sun Ray Appliance terminal 168 on the VLAN. Logically, the VLAN Sun Ray Appliance terminals 168 are on the same Sun Ray backnet network as the Sun Ray Appliance terminals 164.

Sun Ray terminals 164 can communicate with the ATM switch port 158 via Ethernet. Additionally, Ethernet switch 166 can also talk to an ATM switch 158 via Ethernet. ATM switch 158 then communicates using TCP/IP over ATM for example, to the Sun Ray server 142 over WAN 140.

A network architecture such as illustrated schematically in FIG. 6, is capable of supporting a distributed Sun Ray backnet over a wide geographic area, and with a large number of Sun Ray Appliances, thereby bringing the Sun Ray network environment out of the LAN small area environment into a considerably wider and more useful geographic environment.

In accordance with a particular embodiment of the present invention, a Sun Ray network may be established over a metropolitan area network (MAN). Such a Sun Ray system is termed a metropolitan area Sun Ray system (MASS). A white paper published by Sun Microsystems, Inc. May 20, 2002 and entitled “Metropolitan Sun Ray™ Services describes MASS viewed from one aspect, and is incorporated herein as Appendix A.

A MAN is a large corporate network where different LANs are connected into a corporate backbone. However, the difference between the typical corporate network and a MAN, is that the corporate network is often a narrowband network whilst a MAN at least in part relies on a broadband communications technology such as SONET/SDH (ATM). A MAN also spans a relatively large geographical area and traverses long distances compared to a LAN. In a corporate network, security is implemented at the edges whilst policies are implemented in the transfer net. However, communication through the core of the network is relatively unrestricted. In contrast, a MAN has its edge devices typically under the control of subscribers to the MAN services, and not under the MAN owner's or administrator's direct control. However, the core and transfer nets of the MAN are under a very high degree of control via the MAN owner. Thus, the MAN owner may control the network quality and accessibility to be sufficient for implementing MASS over the MAN.

Typically, MANs are owned by telecommunications companies, major Internet service providers or government agencies, although individual companies or corporations may also have their own MAN type networks. A MAN owner has an advantage if the MAN can deliver various types of services other than just data communications. This is because there is a desire to use all of the available MAN bandwidth in order to generate as much revenue as possible from the MAN.

In a particular embodiment in accordance with the present invention, a MAN can be utilised either by the MAN owner or a third party to provide one or more Sun Ray domains over a wide geographic area. A schematic illustration of such an embodiment is illustrated in FIG. 7. A metropolitan area network 170 is provided, in which a Sun Ray server centre 172 is provided as a centralised services computer centre. The Sun Ray server centre 172 comprises four individual Sun Ray servers 142(1) . . . (4) each comprising one or more broadband interface cards 148 running LANE software 150. The MAN 170 network characteristics can be set up in order to provide channels through the network to connect proxy switches such as ATM switches 158 and a respective Sun Ray server 142 to form a particular Sun Ray domain. The proxy switches are configured with per-port VLANs, and the channels to the broadband interface, e.g. ATM uplinks, are included in the VLAN group. A Sun Ray Appliance 174(1) associated with a Sun Ray domain configured by Sun Ray server 142(1) sees all traffic going to and from Sun Ray server 142 (1).

The channel through the MAN 170 can be disregarded since it can be configured in such a way that it does not add any significant latency, is error free and delivers packets in the correct order. Correct packet order delivery is a feature of broadband protocols such as ATM, SONET/SDH since packet order is checked and corrected. In a particular example, the MAN is configured to use LANE 2.0 with UNI trunking. If such a network is not overloaded, the demands for Sun Ray traffic are met without having to take any additional measures.

When dimensioning the MAN network the load that every proxy device adds to the network is taken into account. The maximum capacity of the network (the sum of the potential maximum load of every proxy device should be less than the capacity of the core network) can be determined. By making sure that the core is unlikely or cannot be overrun by proxies, it is possible to ensure that the network will transfer all data. ATM networks self adjust and an overloaded ATM network will throw away packets and not actually breakdown. The capacity of the ATM network in a LANE environment is expanded by adding more (unconfigured) hardware or links to the areas that are affected.

By measurements and tests defining the actual need for bandwidth for a typical proxy, the average capacity required can be deduced. The traffic characteristics have to be monitored over a period of time to determine peak loads.

The MASS owner or administrator has to decide what level of service quality is to be distributed, and should an overload scenario be risked. this should be based on risk analysis and also possibly by manipulating the behaviour of indivudual user to smooth out peaks and troughs and more effectively use the infrastructure. This could be done by a fee structure having peak and off-peak costs, such as a set by telephone companies for example. In addition to this prioritising (Quality of Service, QoS) can be used to ensure certain groups of users always have a certain guaranteed bandwidth, while others compete in a more general pool.

Other proxy switches may be set up to establish further aspects of the Sun Ray domain. As can be appreciated, it is now irrelevant as to the geographic location of the Sun Ray Appliance, since they are all logically on the same LAN. As referred to in FIG. 6, by setting up a port VLANs on the proxy switches 158, it is possible to set up a proxy to contain several VLANs to different Sun Ray domains controlled either by the same server or by different servers. Thus, one VLAN on a proxy can consist of one Ethernet port and one broadband channel, while the rest of the Ethernet ports plus other channels can be set up as a different VLAN.

In the MAN schematically illustrated in FIG. 7, a small Sun Ray site may comprise a single Sun Ray Appliance terminal coupled to an Ethernet port of a proxy switch, such as Sun Ray Appliance terminal 164 illustrated in FIG. 6. Optionally, a larger Sun Ray site may comprise a localised Ethernet network comprising a plurality of VLAN Sun Ray Appliance terminals 168 coupled to an Ethernet switch 166 itself coupled to the Ethernet port of an ATM switch 158, such as illustrated in FIG. 6. Thus, it is clear that although a Sun Ray backnet has to utilise LAN technology, in particular but not exclusively Ethernet, the LAN can be spread out over a large geographical area. Additionally, it is evident that it is possible to have several different Sun Ray LAN domains that are totally separate from each other on the broadband-based MAN at the same time. In this regard there is no limitation as to the number of LANs it is possible to have.

MANs are often implemented over cities and for this reason are sometimes referred to as CITYNETs.

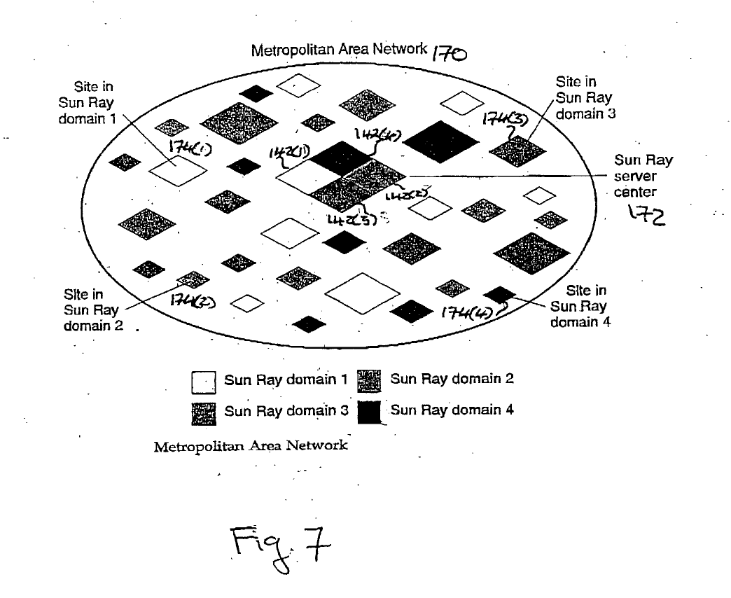

Another schematic representation of an embodiment of a Sun Ray system over a MAN implemented within a city, such as a CITYNET, is illustrated in FIG. 8. A Sun Ray server 142 is coupled to a MAN CITYNET 180 which “tunnels” Ethernet to Sun Ray appliance terminals 146. The logical and physical views of the Sun Ray backnet do not correspond, and it is possible to spread the LAN implemented backnet out onto a broadband network, such as CITYNET 180. Per-port VLANs on a proxy switch configure the Sun Ray backnet LAN such that Sun Ray appliances can be deployed anywhere in the CITYNET 180 provided that the CITYNET network to a proxy switch in that location. The proxy switch can be configured in such a way that other devices 182 can utilise it for other purposes, for example other LANs.

The proxy switch can be contacted via remote login over a maintenance LAN, or by on-site configuration. Remote maintenance and configuration is particulary attractive and may be achieved by assigning an IP address to each switch and then connecting to the IP address for remote configuration of the switch. However, such an approach may be vulnerable to attack since access to the switch IP address would give a person with malicious intent (e.g. a hacker) for example, access to the network/system management function.

The foregoing security concerns may be addressed by establishing one or more service ELANs. Each proxy switch is given an IP address and access to a service ELAN. Thus, it would then be possible to contact the proxy switches in a secure manner from a central remote location. VLANs may then be set up to give access to Sun Ray domains, whilst inhibiting unauthorised access to the switches. and is not represented on the Ethernet side of the proxy switch.

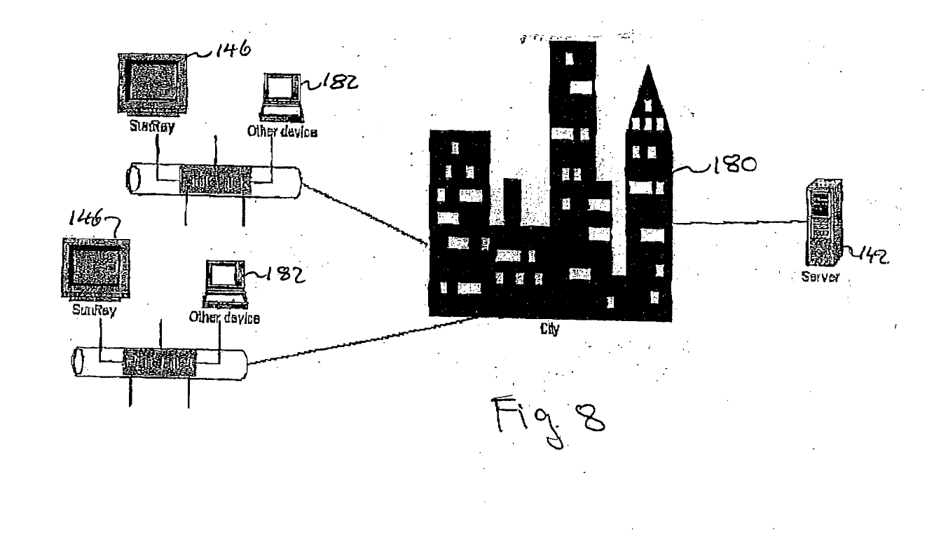

A schematic illustration of a physical layout of an embodiment in accordance with an aspect of the invention is illustrated in FIG. 9. In the embodiment illustrated in FIG. 9, Sun Ray server 142 comprises one Ultra Enterprise (TM) 10 workstation available from Sun Microsystems, Inc and operating with a dual OC3 broadband interface card. Equipment Redundancy is created by having two ASX200 BX backbone switches 176 supplied by Marconi Networks, having three four port OC3 cards and a single one port OC12 card per switch. The ports are both UTP (twisted pair copper cable) and SC fibre connector configured. However, other or additional connector configurations may be used. The fibre ports are both single-mode and multi-mode. Each ASX switch 176 contains a configuration file (LECS.CFG) defining the network topology, and co-located DLE LES/BUS pairs in order to function even in the event of a total failure of one ASX. The local exchange carriers (LEC), i.e. both the proxy switch 158 and the server 142, have dual links in the event of fail over. Furthermore, the server has a UNI-trunked broadband interface cards conglomerate providing multiple links to the network. Additionally, the ASXs 176 are inter-connected through an inter switch link 178. Failure of any ASX or any broadband link should not interrupt the data flow. Failure of two links will not interrupt data unless either both uplinks on either side, i.e. both towards the proxy and towards the server, fail at once.

Utilising long range single mode fibre technology, each link can be up to 60 kilometres long. It will be readily apparent to the ordinarily skilled person that the ASX core can comprise a significantly greater number of switches than that illustrated in FIG. 9, which can be more or less meshed in order to achieve higher redundancy, greater capacity or longer ranges.

Viewed from a functional perspective the physical arrangement of FIG. 9 may be schematically represented as illustrated in FIG. 10. Server 142 communicates over a broadband network, illustrated as broadband ISDN network 180, with a proxy device 158. Sun Ray Appliance terminals 146 are coupled to the proxy device/switch 158. FIG. 10 illustrates Ethernet protocol messages being re-packaged into and transported through a broadband network “cloud”. From an architecture perspective any broadband technology can be utilised provided that the equipment implementing the broadband network can handle Ethernet, or other LAN technology, at the network edges. It is advantageous that the broadband communications technology has trunking capabilities in order to ensure scaling, mode sharing, redundancy and fail over.

This architecture enables scalability within each Sun Ray domain. The architecture is suitable for adding additional Sun Ray domains, either within the same server or through additional servers. It is also possible to use additional servers on each domain to achieve higher redundancy, and of course additional proxy switches throughout the network. Additionally, it is important in a MAN environment that ease of configuration is maintained. Highly complex networks with a large number of Sun Ray domains must be possible to maintain and to develop.

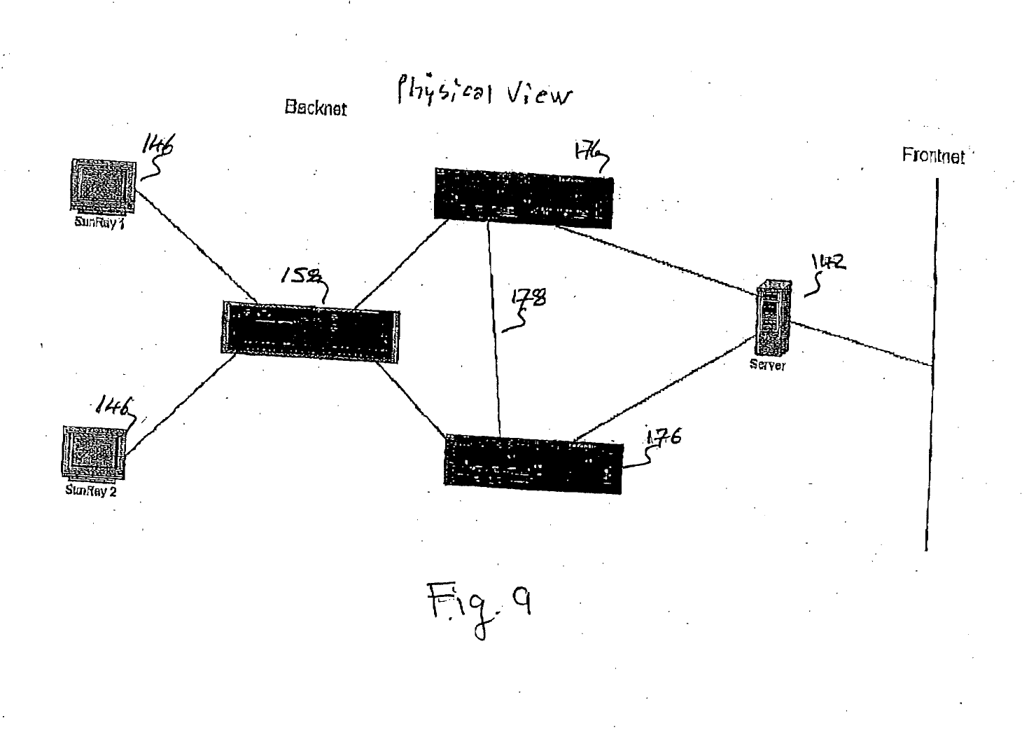

FIG. 11 illustrates an embodiment of the present invention from a logical point of view. FIG. 11 clearly demonstrates that from the Ethernet point of view a Sun Ray system implemented over a broadband network does not differ from how Sun Ray systems have always been deployed. On the one side there is a frontnet towards the public networks, and a backnet towards the private Sun Ray backnet.

A problem encountered when seeking to configure a Sun Ray network system over a broadband network by utilising a broadband interface card technology is that Sun Ray server software cannot readily be utilised on a non-Ethernet/LAN interface cards. In particular, Sun Ray software cannot readily be utilised or made to work on broadband interface cards such as for-handling SONET/SDH-family communications. Sun Ray software can only be installed on regular Ethernet based LAN interfaces, i.e. 10/100/1000 Mb cards.

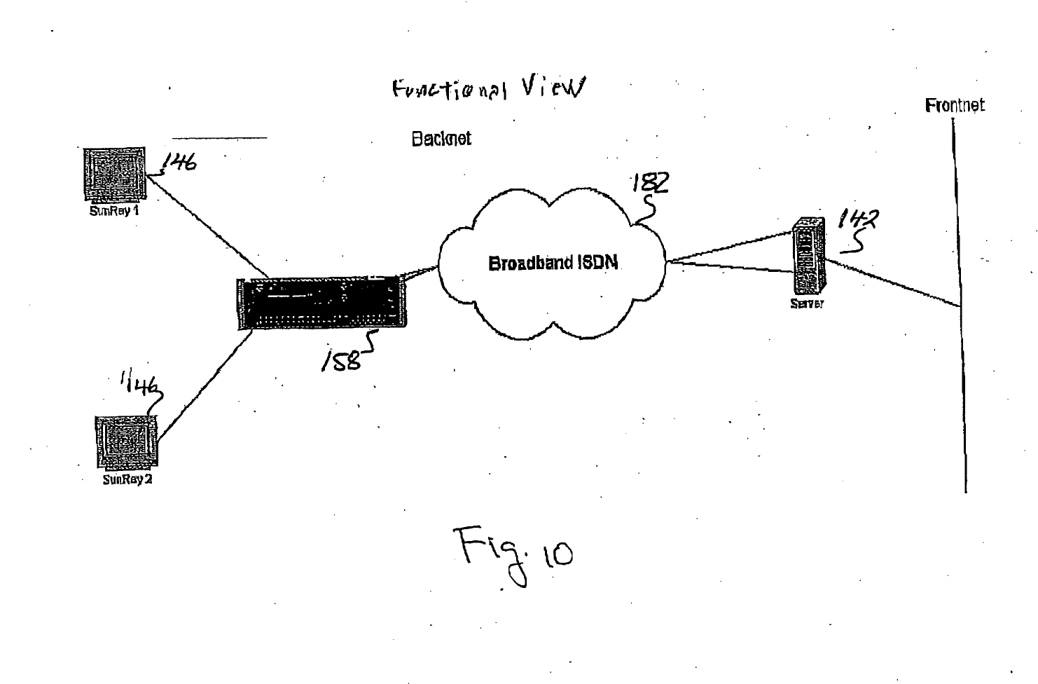

FIG. 12 illustrates a process flow for establishing Sun Ray server software for communication over broadband, e.g. SONET/SDH-type interfaces. At Step 10, Sun Ray server software is first installed on an Ethernet LAN card in a Sun Ray server. The installed Sun Ray server software is then tested at Step 12. Finally, the Sun Ray server software is forced to use the SONET/SDH capable broadband interface card at Step 14. Typically, the Sun Ray server software may be forced to use the BIC interface by modifying the name of the interface file in the server software from the Ethernet LAN card name to the BIC interface card name.

FIG. 13 illustrates the process flow when upgrading a Sun Ray server configured to operate with a BIC interface. At step S20 the Sun Ray server software is pointed back to the Ethernet LAN card, and at Step S22 the up-grade Sun Ray server software is installed on the Ethernet LAN card. Then at Step S24, the Sun Ray server software is forced back to using the BIC interface. The foregoing represents a relatively simple yet effective way in which to configure a Sun Ray server to utilise a BIC interface for implementing a Sun Ray network environment over a wide area.

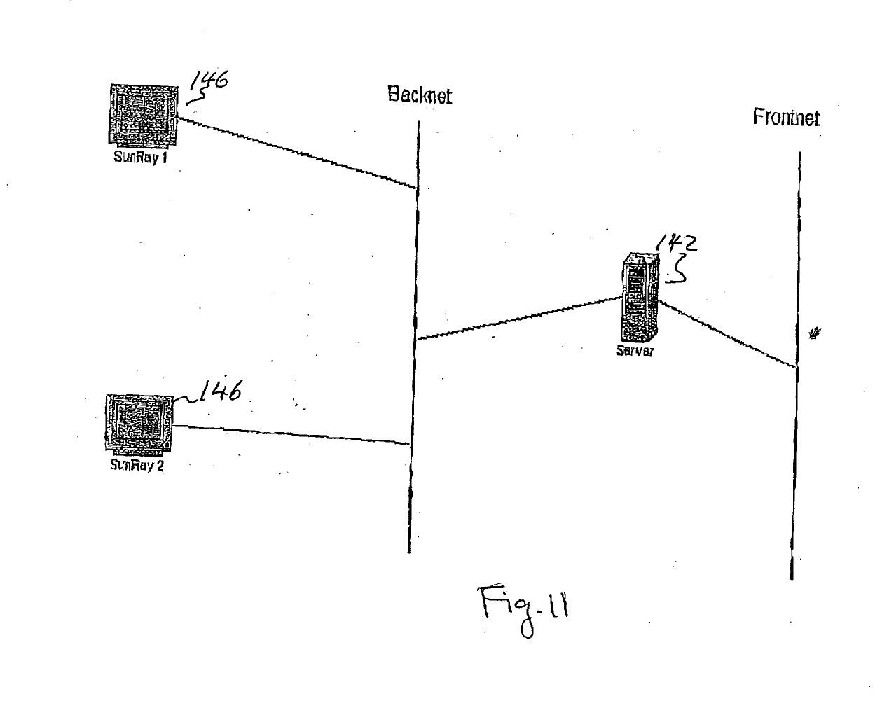

A particular example of a data centre which may be used in conjunction with a Sun Ray system such as MASS is the Service Delivery Network (SDN) provided by Sun Microsystems, Inc, Palo Alto, Calif. and described in document part no. 816-3550-10 dated December 2001, Revision A and which was available, at least on the May 15, 2002 from URL “http:\\[World Wide Web].sun.com\service\sunps\architect\delivery\sdn-arch-overview.pdf”, and ncorporated herein in full as Appendix B. FIG. 14 illustrates the SDN 190 components for a data services platform providing a scalable data centre. In the example illustrated in FIG. 14 a client 192 communicates with SDN 190 over communications network 194, for example, but not exclusively, the Internet. SDN 190 interfaces to the network 194 via a router 196.

The SDN 190 architecture is a client-service architecture, meaning that a client 192 connects to a service 198 in the SDN 190, and not to a particular server. Any server supporting the service to which the client wishes to connect is appropriate. Types of services such as portal services, directory services and data services are grouped together in service domains 198 as illustrated in FIG. 14. A particular type of service provision may be scaled up, or indeed scaled down, by increasing or decreasing the number of servers supporting that service.

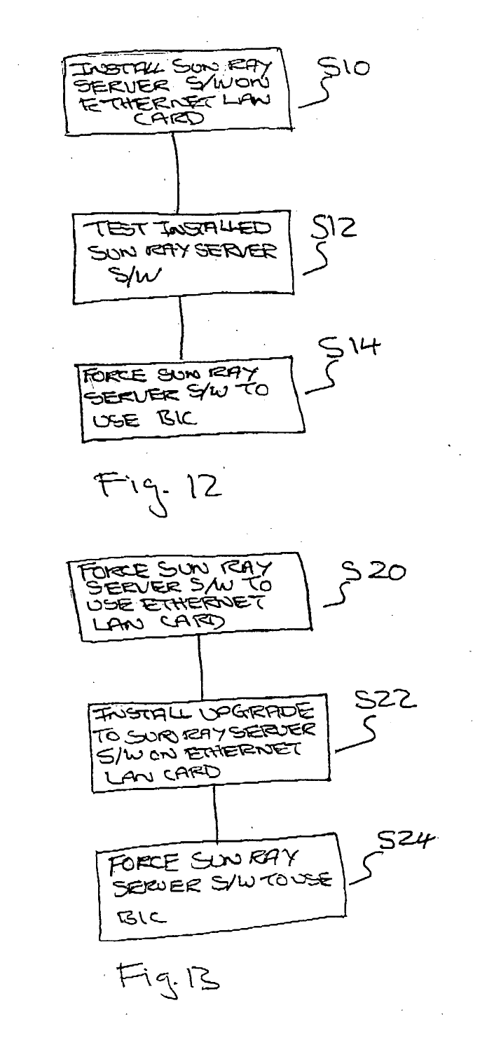

A SDN 190 logical architecture overview is illustrated in FIG. 15 and illustrates a service module 200 comprising various service domains 198 supporting mail, web, wireless and portal services.

Generally services can be defined as three different types: end-user, support and infrastructure services. End-user services are typically provided directly to an end-user and might include a web site, the ability to send e-mail or a used net group for example. Support services directly support end-user services and may include an application server providing dynamic content for a web site or e-commerce applications. However, the end-user service is the service access point to the SDN, and users do not directly initiate connections into a support service.

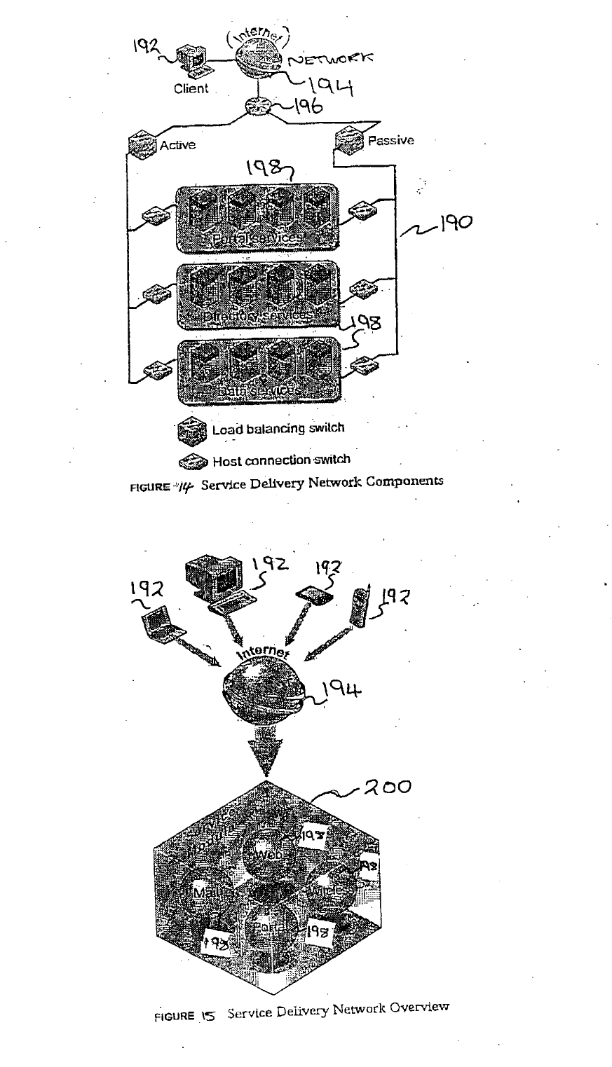

Infrastructure services manage the internal operation and support for the SDN and generally include system and network management services. An example of an infrastructure service would be an internal DNS service. Generally, infrastructure services should not directly interact with end-user services. The typical network equipment components for a service module 200 are illustrated in FIG. 16. Load balancing switches 202 balance load requirements between host connection switches 204 to the various service domains 198.

The host connection switches 204 provide the simple function of attaching hosts and servers to the SDN. They can also be used to link service modules together when using a distribution module, which shall be described later.

Load balancing switches 202 provide routing between and to service domains within a service module 200. The load balancing switches are configured to provide high availability and distribute access to service domains 198, and typically comprise high-speed, high-performance switches, typically replaced the lower three switches and routers found in conventional data centre access network topologies. In this way, switching, distribution and load balancing capabilities are provided in the SDN thereby supporting intelligent service routing to provide high availability and reliability of service access.

FIG. 17 shows a graphical representation of a service domain, which is a logical grouping of related services and the hosts, servers that provide these services. As shown in FIG. 17, the illustrated service domain includes four servers, Host A, Host B, Host C and Host D. The services are split up into service domains typically by way of logical grouping so for example front e-mail services including POP and IMAP belong to the same service domain. Additionally, services in the same service domain should typically have the same security requirements. Furthermore, a service domain is easier to maintain, for example by way of maintaining the host servers, if the services offered in the domain are limited to a particular type of service. For example, a service domain may only offer HTTP, which provides the simple maintenance since only one traffic protocol may be maintained. Additionally, internal services should be load balanced and therefore should be in separate service domains to allow traffic to follow the intended load distribution set up within the SDN.

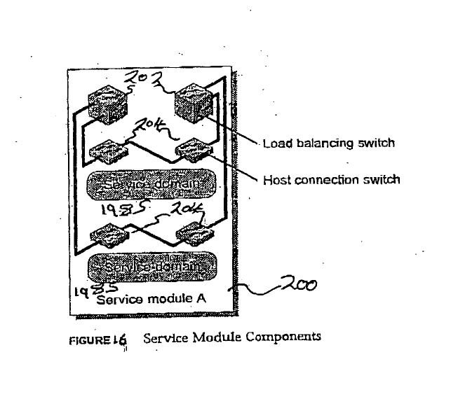

The service module 200 is the basic SDN building block, and consists of physical network hardware, server connections and software applications that make up the servers to be delivered. The components of a service module 200 are graphically illustrated in FIG. 18. Each service module 200 contain service domains 198, with each service domain providing a specific service for example WAP gateway functionality, or particular network protocols such as HTTP or NNTP. By limiting services to particular service domains provides for each service to be scaled individually, thereby enhancing the scalability of the SDN. The primary service interface for the SDN is the service delivery interface 206. The service delivery interface 206 provides an integration point to upstream access providers such as a corporate Intranet or WAN access to a network 194, for example the Internet.

Additionally, service module 200 is connected to management network 208 and a backup network 210.

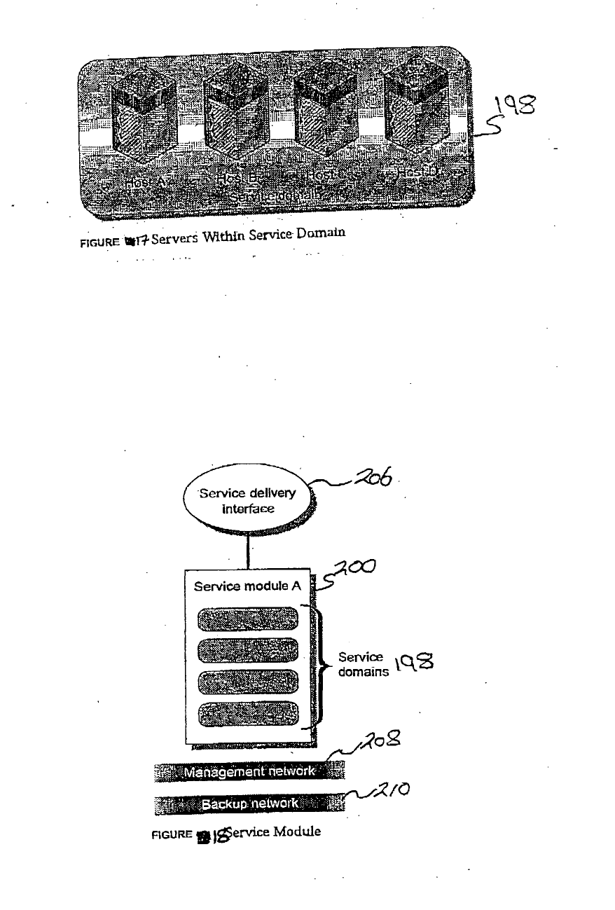

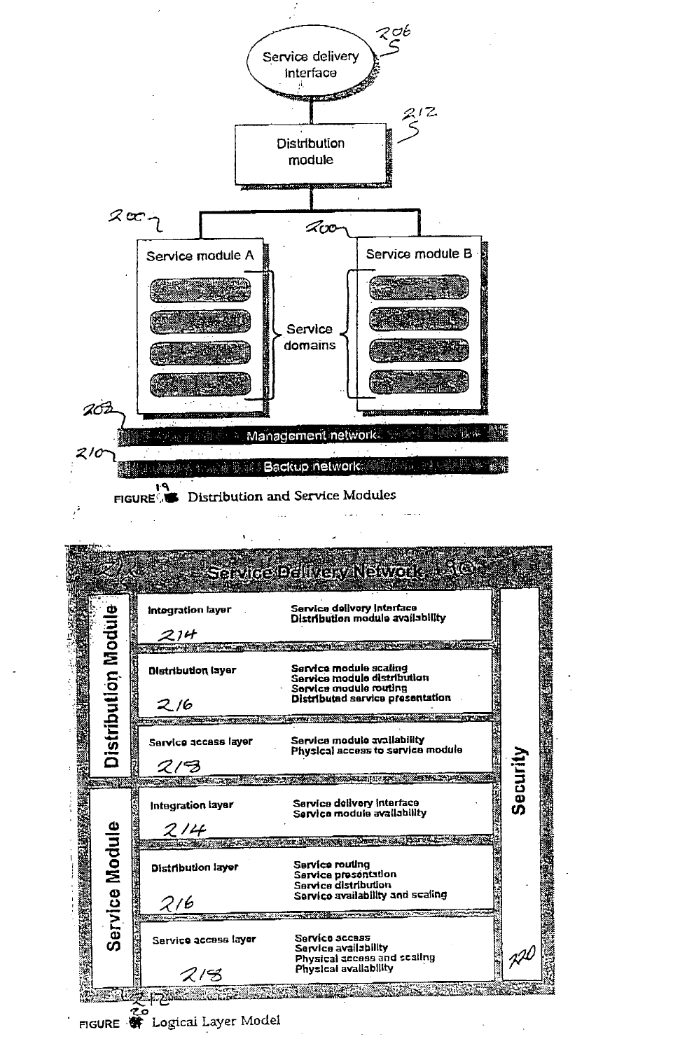

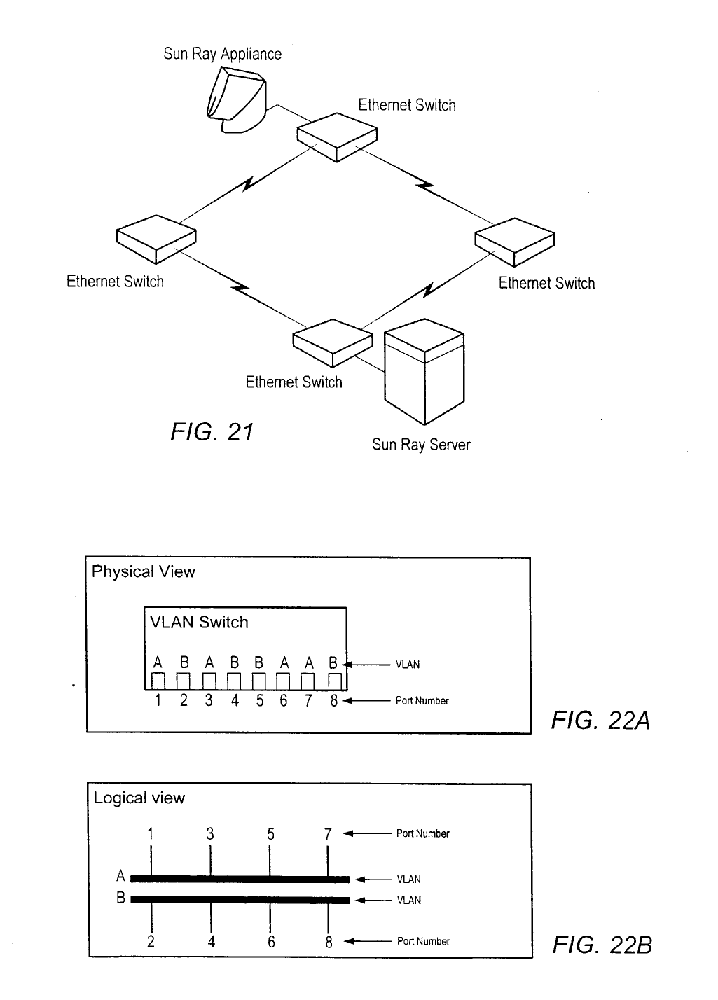

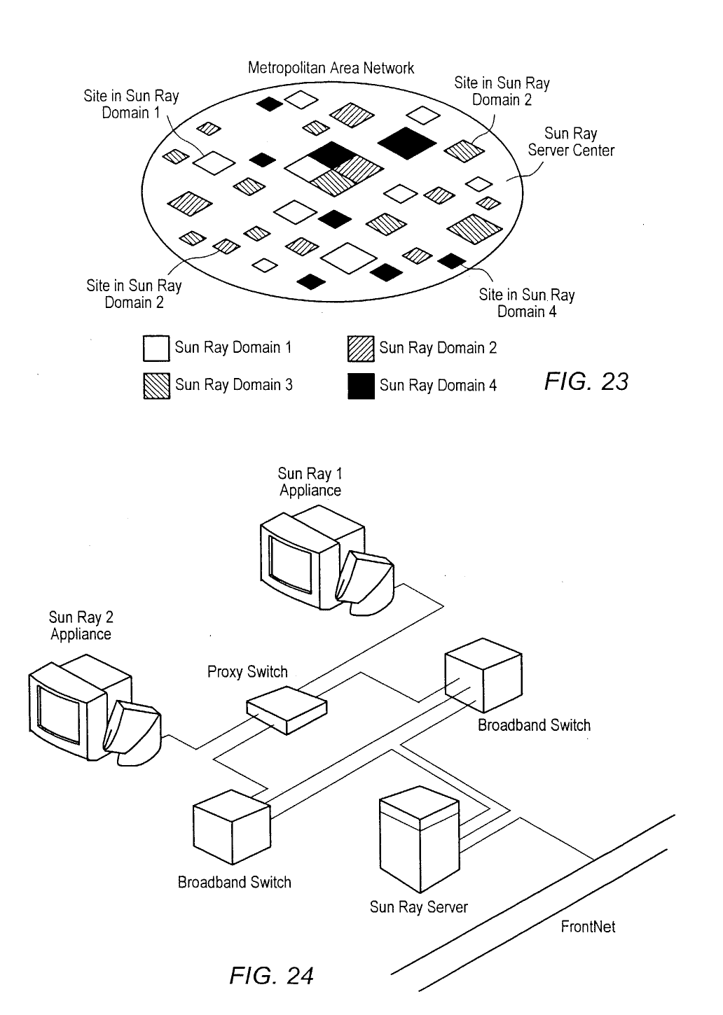

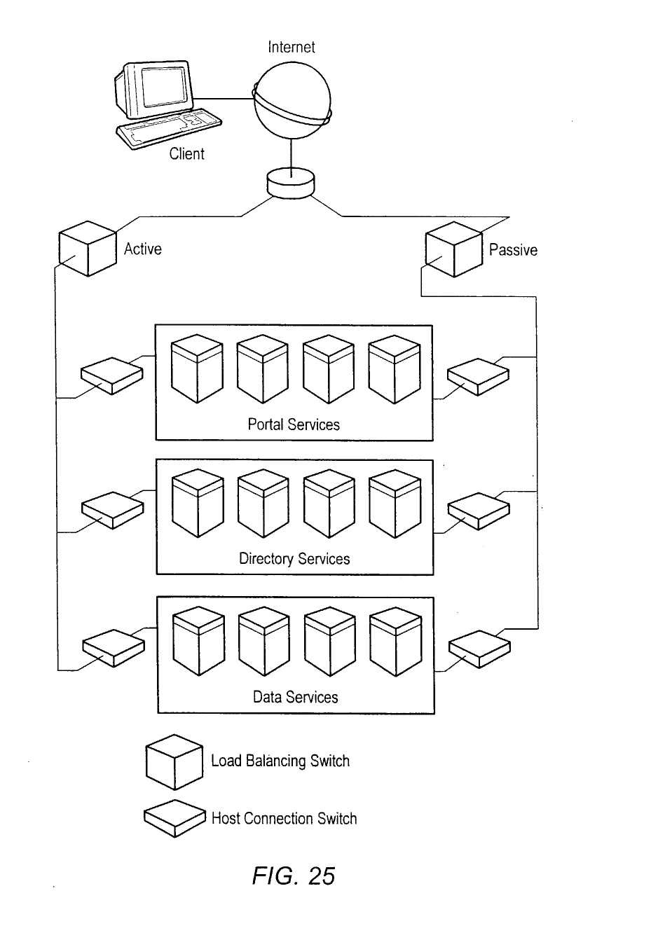

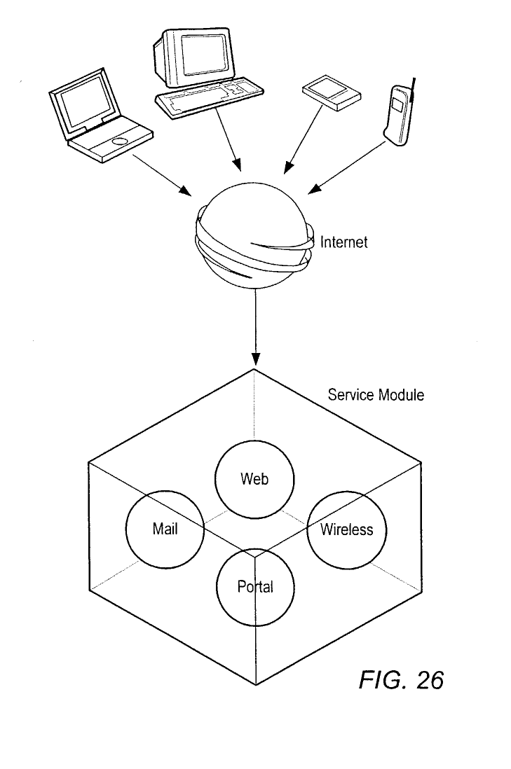

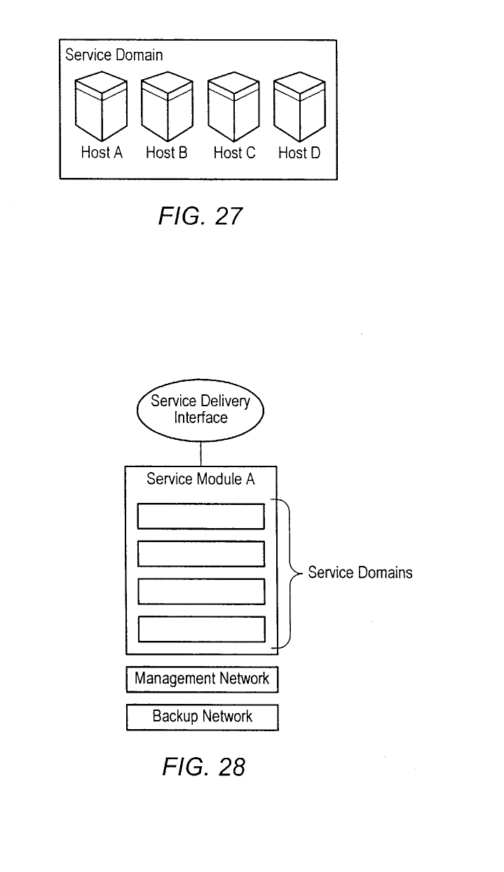

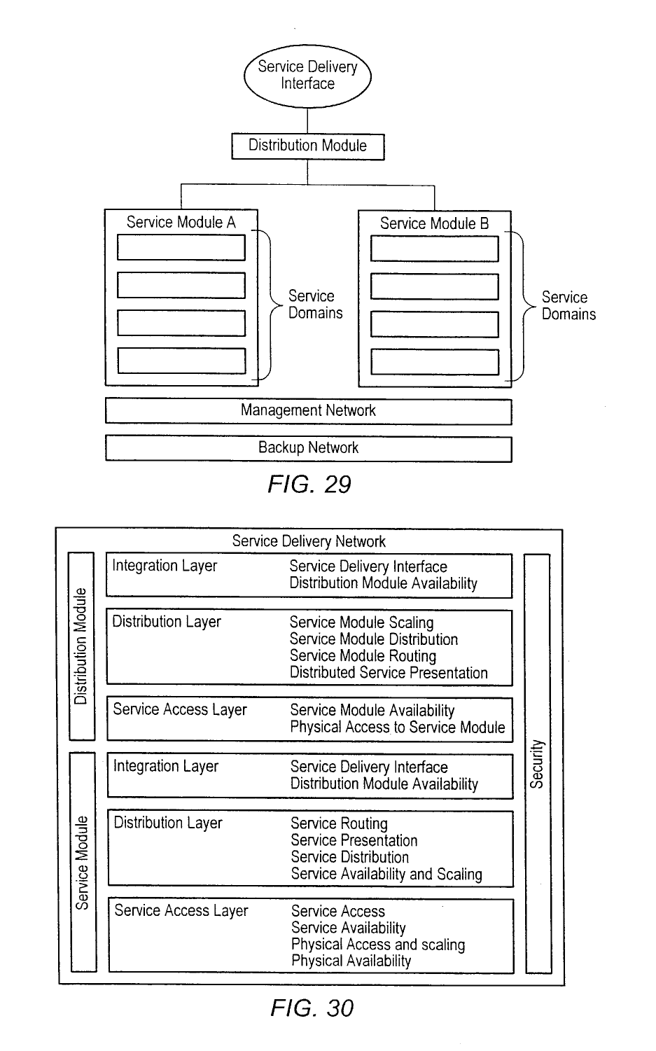

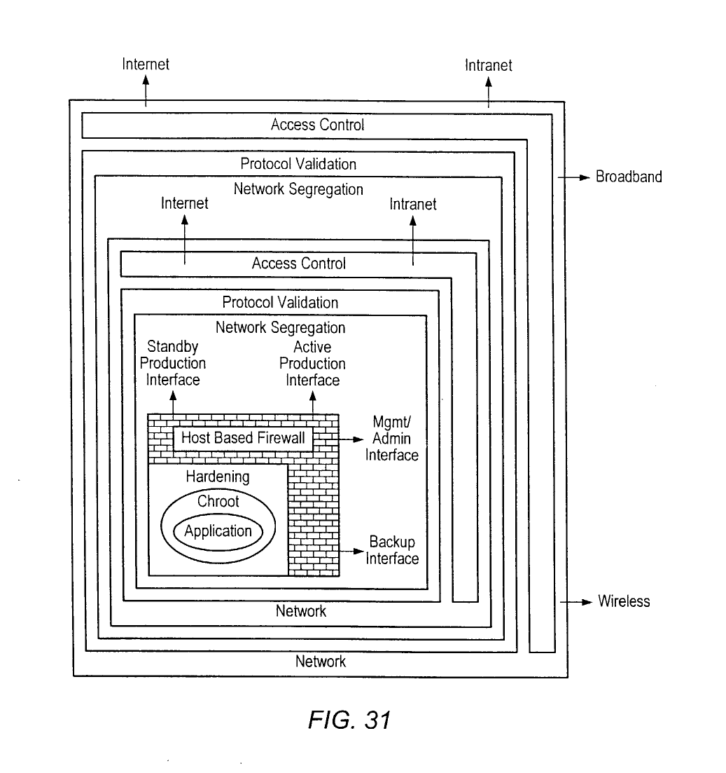

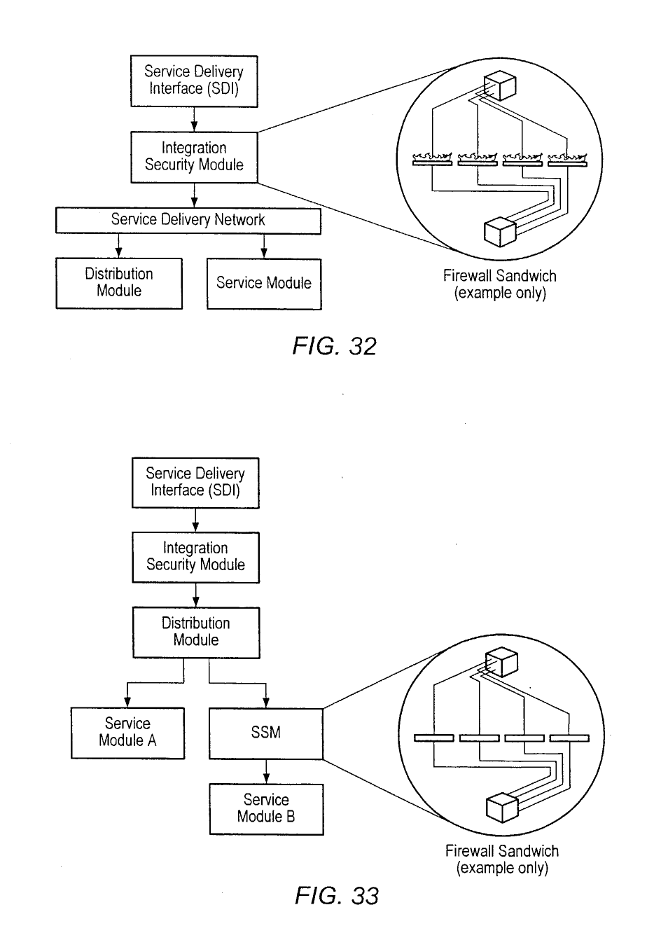

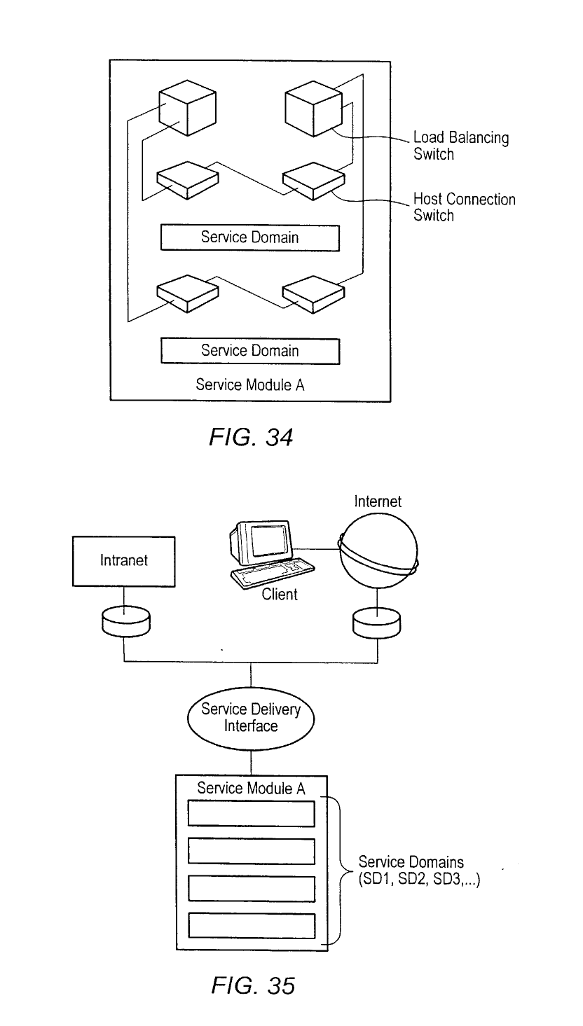

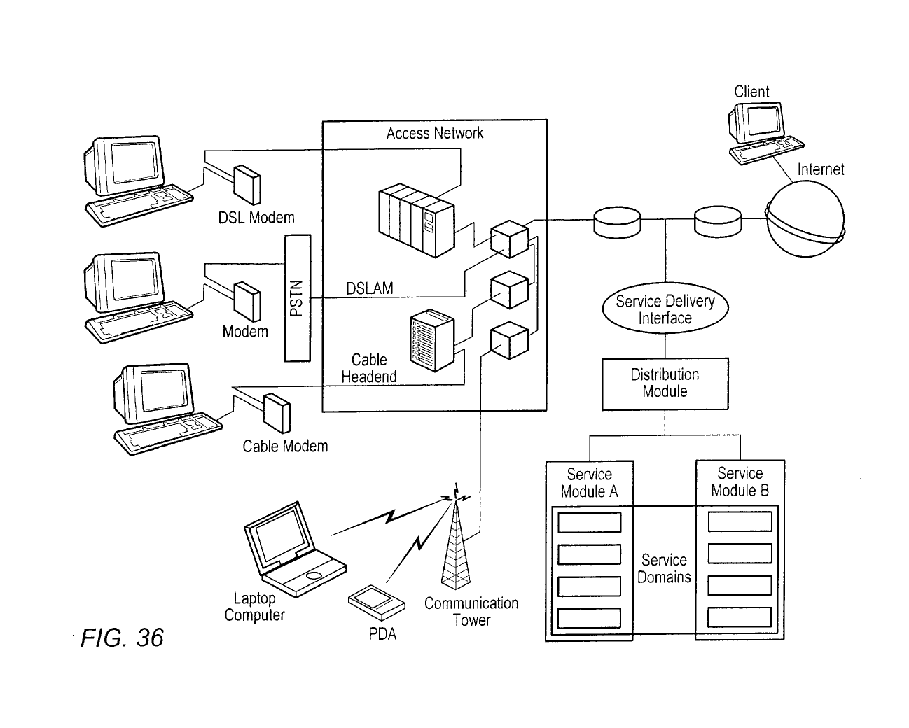

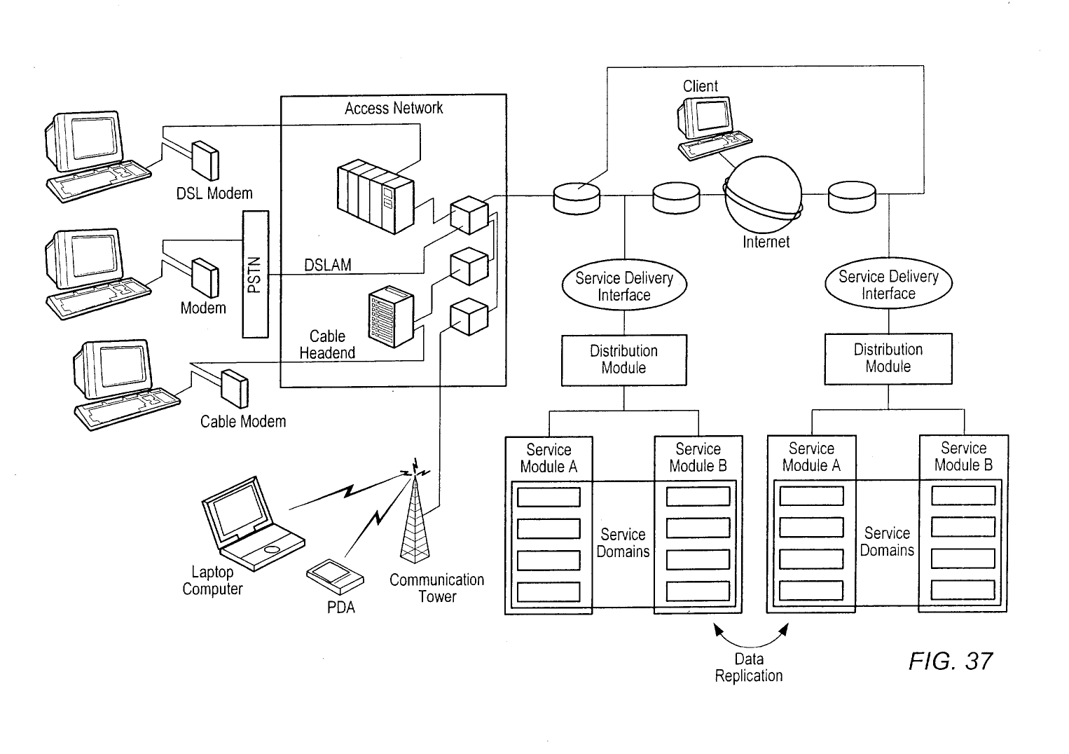

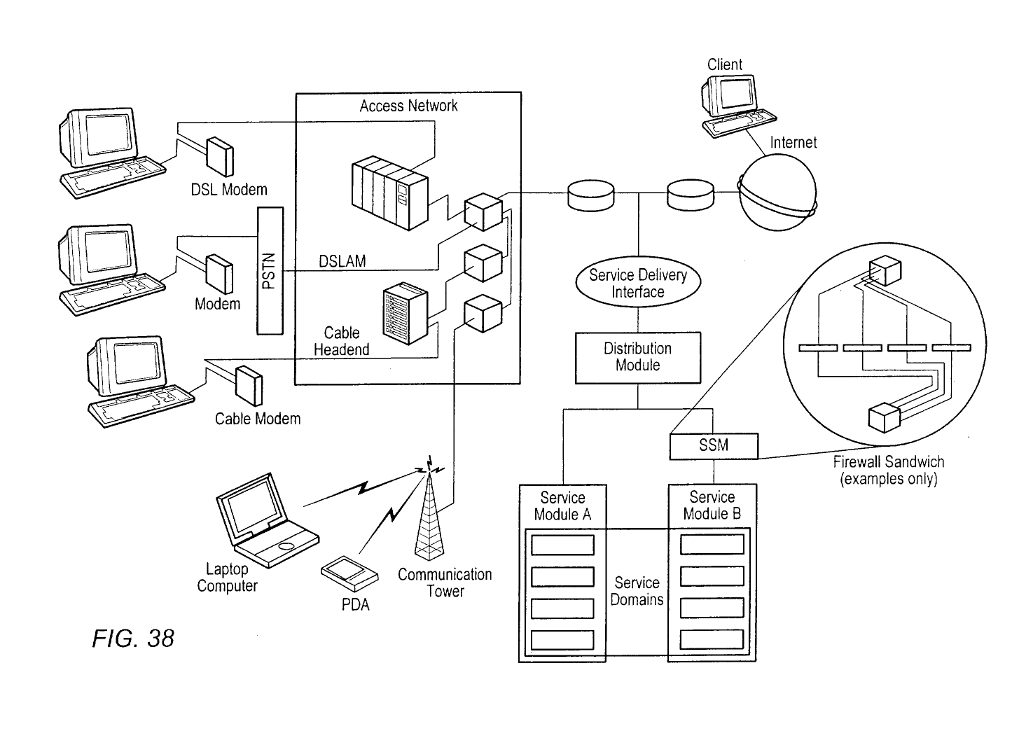

Optionally, service modules may be coupled to a distribution module enabling several service modules to work together and to aggregate services to the service delivery interface 206. A graphical illustration of the components of a SDN implementing a distribution module is illustrated in FIG. 19. Distribution module 212 sits between the service delivery interface 206 and the mulitplicity of service modules 200, illustrated in FIG. 19 as service module A and service module B. Utilisation of a distribution module 212 enhances the scalability of the SDN since more than one service module may be coupled via the same service delivery interface 206.

The SDN logical layout model is illustrated in FIG. 20 with reference to the primary functions of the service and distribution modules described in terms of three layers, and the physical component that provides these functions. Each module comprises three layers, an integration layer 214, a distribution layer 216 and a service access layer 218.

The integration layer 214 for each module is provided by the service delivery interface 206 and provides the physical connectivity and availability features to host, other networks devices and other networks. It also hosts the services provided by the infrastructure.

The distribution layer provides routing, distribution, public service presentation and also provides for intelligent service routing. The service access layer 218 provides the interface between the distribution layer, the service instances and the physical components within the network architecture, including the various modules that make up the SDN 190. An integrated security module 220 may also be incorporated within the SDN and interfaces with each layer for each module within the SDN.

A service module 200 may include a domain 198 supporting a Sun Ray service and comprising Sun Ray servers as host servers. Each of the one or more Sun Ray servers in the Sun Ray service domain include an interface card suitable for connecting to the SDN backbone. Suitably the SDN backbone is an Ethernet, and each of the one or more Sun Ray servers includes an Ethernet interface card for communicating with SDN servers over the SDN backbone. In this manner, the Sun Ray servers may provide a login function to the SDN for the client terminals on the Sun Ray system. For a MASS implementation, MASS configured Sun Ray servers, i.e. including broadband interface cards configured with a LANE module, may communicate with non-computational, low processing power thin client terminals which may connect to an SDN for the delivery of various services such as business and office applications, e-mail and other services from geographically remote locations. In view of the foregoing description of particular embodiments of the invention it will be appreciated by a person skilled in the art that various additions, modifications and alternatives thereto may be envisaged.

For example, further aspects of the invention include a thin client network server mechanism comprising a thin client network management and control module, and a network interface mechanism operable with the thin client management and control module to provide a communications link between the server mechanism and one or more thin client computer systems. The network interface mechanism may include a broadband communications technology network interface and a LAN emulation (LANE) module interoperable with the broadband communications technology network interface to provide a communications link between the server mechanism and one or more thin client computer systems over the broadband communications technology network.

Yet a further aspect of the present invention is a thin client server mechanism, comprising a thin client network management and control module, and a network interface mechanism operable with the management and control module to provide a communications link between the server mechanism and one or more thin client computer systems. The network interface mechanism may include a broadband network interface module and a LAN emulation (LANE) module interoperable with the broadband communications technology interface module to provide a LAN interface type environment for broadband communications technology network.

In so far as embodiments of the invention described above are implementable, at least in part, using a software-controlled programmable processing device such as a Digital Signal Processor, microprocessor, other processing devices, data processing apparatus or computer system, it will be appreciated that a computer program or program element for configuring a programmable device, apparatus or system to implement the foregoing described methods, mechanisms and/or modules is envisaged as an aspect of the present invention. The computer program or program element may be embodied as source code and undergo compilation for implementation on a processing device, apparatus or system, or may be embodied as object code, for example. The skilled person would readily understand that the term computer in its most general sense encompasses programmable devices such as referred to above, and data processing apparatus and computer systems.

Suitably, the computer program or program element is stored on a carrier medium in machine or device readable form, for example in solid-state memory, optical or magneto-optical memory such as a readable and/or writable disk for example a compact disk and a digital versatile disk, or magnetic memory such as disc or tape, and the processing device utilises the program, program element or a part thereof to configure it for operation. The computer program or program element may be supplied from a remote source embodied in a communications medium such as an electronic signal, including radio frequency carrier wave or optical carrier wave. Such carrier media are also envisaged as aspects of the present invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

For the avoidance of doubt, the term “comprising” used in the description and claims should not be construed to mean only “consisting only of”.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What we claim is:

1. A server mechanism for a thin client network domain distributed over a broadband network, comprising:
a thin client network domain management module;
a network interface mechanism including a broadband network interface module and a narrowband emulation module interoperable with the broadband network interface module to provide a communications link to one or more thin client terminals over a broadband network;
said domain management and/or control module interoperable with said network interface mechanism to provide a thin client network domain environment over said broadband network.

2. A server mechanism according to claim 1, wherein said thin client network domain management module includes a directory of file identifiers, said directory modified to substitute an identifier of said network interface mechanism for an identifier of a narrowband network interface module.

3. A server mechanism according to claim 1, further comprising a further network interface mechanism including a broadband communications technology network interface module and a narrowband emulation module interoperable with the thin client network domain management module to configure a further thin client network domain environment over said broadband network.

4. A server mechanism according to claim 1, wherein said narrowband emulation module comprises a Local Area Network Emulation (LANE) module.

5. A server mechanism according to claim 4, wherein said LANE module is operable for one or more of the following LAN protocols:
Ethernet; Token Rings; and FDDI.

6. A server mechanism according to claim 1, further comprising a narrowband network interface module.

7. A server mechanism according to claim 6, wherein said narrowband network interface module comprises a LAN module.

8. A server mechanism according to claim 7, wherein said LAN module is operable for one or more of the following LAN protocols: Ethernet; Token Rings; and FDDI.

9. A server mechanism according to claim 1, said broadband communications technology network interface module operable for one or more of Classical IP (CLIP), Permanent Virtual Circuits (PVC), Asynchronous Transfer Mode (ATM), Synchronous Optical Network (SONET) and Synchronous Digital Hierarchy (SDH).

10. A data processing apparatus configured to implement a server mechanism according to claim 1.

11. A computer network, comprising:
a data processing apparatus according to claim 10 coupleable to a broadband network; and,
a thin client terminal configured to be operable with a narrowband protocol;
said thin client terminal coupleable to said broadband network by a broadband switch module configured to provide an interface between a thin client network type environment and said broadband network for communicating between the thin client terminal and the data processing apparatus.

12. A computer network according to claim 11, wherein said thin client terminal is coupleable to said broadband switch module via a narrowband switch module.

13. A computer network according to claim 11, wherein said data processing apparatus is disposed in a Service Delivery Network server architecture and is configured to implement an access service to said Service Delivery Network for said thin client terminal.

14. A computer network according to claim 12, said narrowband switch comprising a LAN switch performing a virtual LAN in cooperation with said broadband switch and said data processing apparatus.

15. A computer network according to claim 14, wherein said LAN switch is operable for one or more of the following protocols: Ethernet; Token Ring; and FDDI.

16. A computer network according to claim 10, wherein said broadband communications technology network comprises at least one of the following communications technologies: Classical IP (CLIP); Permanent Virtual Circuits (PVC); Asynchronous Transfer Mode (ATM); Synchronous Optical Network (SONET); and Synchronous Digital Hierarchy (SDH).

17. A data processing apparatus according to claim 10, implemented as a computer system.

18. A server mechanism for a thin client network domain distributed over a broadband network, comprising:
a thin client network domain control module;
a network interface mechanism including a broadband network interface module and a narrowband emulation module interoperable with the broadband network interface module to provide a communications link to one or more thin client terminals over a broadband network;
said domain management and/or control module interoperable with said network interface mechanism to provide a thin client network domain environment over said broadband network.

19. A server mechanism according to claim 18, wherein said thin client network domain control module includes a directory of file identifiers, said directory modified to substitute an identifier of said network interface mechanism for an identifier of a narrowband network interface module.

20. A server mechanism according to claim 18, further comprising a further network interface mechanism including a broadband communications technology network interface module and a narrowband emulation module interoperable with the thin client network domain control module to configure a further thin client network domain environment over said broadband network.

21. A method for forming a thin client network domain over a broadband network, comprising:
configuring a thin client server mechanism with a broadband network interface;
emulating a LAN controller on said thin client server mechanism; configuring one or more broadband edge switches for communication with one or more thin client terminals in said domain to form a virtual private network with said thin client server mechanism; and
communicating LAN signals to said one or more thin client terminals over said virtual private network.

22. A method of forming a thin client network domain over a broadband network, comprising:
forming a virtual local area network over said broadband; configuring a thin client server mechanism to emulate a LAN controller over a broadband network interface to control said virtual local area network; and
coupling one or more thin client terminals to said virtual LAN for communicating with said thin client server mechanisms.

23. A method of configuring a thin client server mechanism to form a thin client network domain over a broadband network, comprising:
initialising a thin client server mechanism with a LAN module;
installing a LAN emulation (LANE) module interoperable with a broadband network interface; and
modifying a pointer to said LAN module to point to said LANE module.

24. A computer usable medium having computer or processor-readable program code embodied therein operable to effect the performance of a thin client server mechanism, said computer readable program comprising computer readable program code for:
configuring a thin client server mechanism with a broadband network interface;
emulating a LAN controller on said thin client server mechanism; configuring one or more broadband edge switches for communication with one or more thin client terminals in said domain to form a virtual private network with said thin client server mechanism; and
communicating LAN signals to said one or more thin client terminals over said virtual private network.

25. A computer usable medium according to claim 24, wherein the computer usable medium comprises at least a one of the following said media: a signal including an optical, electronic or RF carrier signal, a magnetic disk or tape, solid-state memory, an optical readable and or writable disk, a compact disc and a digital versatile disc.

26. A computer usable medium having computer or processor readable program code embodied therein operable to effect the performance of a thin client server mechanism, said computer readable program comprising computer readable program code for:
forming a virtual local area network over said broadband; configuring a thin client server mechanism to emulate a LAN controller over a broadband network interface to control said virtual local area network; and
coupling one or more thin client terminals to said virtual LAN for communicating with said thin client server mechanisms.

27. A computer usable medium having computer or processor readable program embodied therein, said program operable in a computer comprising a thin client server mechanism for:
configuring a thin client server mechanism with a broadband network interface;
emulating a LAN controller on said thin client server mechanism; configuring one or more broadband edge switches for communication with one or more thin client terminals in said domain to form a virtual private network with said thin server mechanism; and
communicating LAN signals to said one or more thin client terminals over said virtual private network.

28. A computer usable medium having computer or processor readable program embodied therein, said program operable in a computer comprising a thin client server mechanism for:
forming a virtual local area network over said broadband; configuring a thin client server mechanism to emulate a LAN controller over a broadband network interface to control said virtual local area network; and
coupling one or more of thin client terminals to said virtual LAN for communicating with said thin client server mechanisms.

29. A thin client network server mechanism, comprising:
a thin client network management module; and
a network interface mechanism operable with the thin client management and/or control module to provide a communications link between the server mechanism and one or more thin client computer systems, the network interface mechanism including a broadband network interface and a LAN emulation (LANE) module interoperable with the broadband network interface to provide a communications link between the server mechanism and one or more thin client computer systems over the broadband network.

30. A thin client server mechanism, comprising:
a thin client network management module; and
a network interface mechanism operable with the management and/or control module to provide a communications link between the server mechanism and one or more thin client computer systems, the network interface mechanism including a broadband network interface module and a LAN emulation (LANE) module interoperable with the broadband communications technology interface module to provide a LAN interface type environment for the broadband network.

31. A thin client network server mechanism, comprising:
a thin client network control module; and
a network interface mechanism operable with the thin client management and/or control module to provide a communications link between the server mechanism and one or more thin client computer systems, the network interface mechanism including a broadband network interface and a LAN emulation (LANE) module interoperable with the broadband network interface to provide a communications link between the server mechanism and one or more thin client computer systems over the broadband network.

32. A thin client server mechanism, comprising:
a thin client network control module; and
a network interface mechanism operable with the management and/or control module to provide a communications link between the server mechanism and one or more thin client computer systems, the network interface mechanism including a broadband network interface module and a LAN emulation (LANE) module interoperable with the broadband communications technology interface module to provide a LAN interface type environment for the broadband network.
